(19) United States
(12) Patent Application Publication
(10) Pub. No.: US 2025/0104921 A1
(43) Pub. Date: Mar. 27, 2025

(54) MULTILAYER CERAMIC ELECTRONIC COMPONENT

(71) Applicant: Murata Manufacturing Co., Ltd., Nagaokakyo-shi (JP)

(72) Inventor: Ken TOMINAGA, Nagaokakyo-shi (JP)

(21) Appl. No.: 18/976,534

(22) Filed: Dec. 11, 2024

Related U.S. Application Data
(63) Continuation of application No. PCT/JP2023/016532, filed on Apr. 26, 2023.

(30) Foreign Application Priority Data
Jul. 28, 2022 (JP) 2022-120422

(51) Int. Cl. H01G 4/232; H01G 4/30

(52) U.S. Cl. CPC H01G 4/2325; H01G 4/30

(57) ABSTRACT

A multilayer ceramic electronic component includes a multilayer body, first and second outer electrodes respectively extending from first and second end surfaces of the multilayer body to each of first and second main surfaces. The first outer electrode includes a first main surface inclined portion extending from the first main surface side of the multilayer body to the first end surface side. The second outer electrode includes a second main surface inclined portion extending from the first main surface side of the multilayer body to the second end surface side. The first main surface inclined portion covers a ridge portion defined by the first main surface and the first end surface of the multilayer body. The second main surface inclined portion covers a ridge portion defined by the first main surface and the second end surface of the multilayer body.

### CROSS REFERENCE TO RELATED APPLICATIONS

This application claims the benefit of priority to Japanese Patent Application No. 2022-120422 filed on Jul. 28, 2022 and is a Continuation Application of PCT Application No. PCT/JP2023/016532 filed on Apr. 26, 2023. The entire contents of each application are hereby incorporated herein by reference.

### BACKGROUND OF THE INVENTION

### 1. Field of the Invention

The present invention relates to multilayer ceramic electronic components.

### 2. Description of the Related Art

In the related art, a multilayer ceramic capacitor is known as a multilayer ceramic electronic component. A common multilayer ceramic capacitor is known to include a multilayer body in which a plurality of inner electrode layers and dielectric layers are alternately stacked, and outer electrodes electrically bonded to the inner electrode layers. Generally, a multilayer ceramic capacitor is mounted on a substrate by being soldered on the substrate by using a method such as reflow.

On the other hand, the solder used to bond the outer electrode of the multilayer ceramic capacitor to the substrate shrinks due to a temperature change, causing thermal stress. There is a problem that, for example, cracks occur when the thermal stress is applied to the multilayer ceramic capacitor main body.

As a means of solving such a problem, for example, Japanese Unexamined Patent Application Publication No. 11-162771 discloses a technique in which an epoxy thermosetting resin layer for stress absorption is provided on a baked electrode layer of an outer electrode.

However, the above related art has the following problems. That is, when the resin layer for stress absorption is provided on the outer electrode, the dimension of the multilayer ceramic capacitor itself increases accordingly, and problems occur such as a decrease in the degree of freedom in mounting.

### SUMMARY OF THE INVENTION

Example embodiments of the present invention provide multilayer ceramic electronic components and methods for manufacturing multilayer ceramic electronic components, which are each able to reduce or prevent an influence of thermal stress due to solder shrinkage while reducing or preventing an increase in dimensions of a component in a multilayer ceramic electronic component, such as a multilayer ceramic capacitor.

A multilayer ceramic electronic component according to an example embodiment of the present invention includes a multilayer body including a plurality of stacked ceramic layers, a first main surface and a second main surface facing each other in a height direction, a first side surface and a second side surface facing each other in a width direction orthogonal or substantially orthogonal to a stacking direction of the plurality of ceramic layers, a first end surface and a second end surface facing each other in a length direction orthogonal or substantially orthogonal to the stacking direction and the width direction, a first inner electrode layer stacked alternately with the plurality of ceramic layers and exposed on the first end surface, and a second inner electrode layer stacked alternately with the plurality of ceramic layers and exposed on the second end surface, a first outer electrode extending from the first end surface of the multilayer body to each of the first main surface and the second main surface, and a second outer electrode extending from the second end surface of the multilayer body to each of the first main surface and the second main surface. The first outer electrode includes a first main surface inclined portion extending from a side of the first main surface of the multilayer body to a side of the first end surface, and the second outer electrode includes a second main surface inclined portion extending from the side of the first main surface of the multilayer body to a side of the second end surface.

In a multilayer ceramic electronic component according to an example embodiment of the present invention, the first outer electrode includes a first main surface inclined portion extending from a first main surface side of the multilayer body to a first end surface side, and the second outer electrode includes a second main surface inclined portion extending from the first main surface side of the multilayer body to a second end surface side. Therefore, stress concentration on the bonding portion between the first outer electrode and the multilayer body and the like and the bonding portion between the second outer electrode and the multilayer body and the like is reduced or prevented, and cracks in the multilayer body can be reduced or prevented.

According to example embodiments of the present invention, it is possible to provide multilayer ceramic electronic components that are each able to reduce or prevent the influence of thermal stress due to solder shrinkage while reducing or preventing an increase in the dimensions of the component.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing a multilayer ceramic capacitor according to a first example embodiment of the present invention.

FIG. 2 is a front view showing the multilayer ceramic capacitor according to the first example embodiment of the present invention.

FIG. 3 is a side view showing the multilayer ceramic capacitor according to the first example embodiment of the present invention.

FIG. 4 is a cross-sectional view taken along line IV-IV in FIG. 1.

FIG. 5 is a cross-sectional view taken along line V-V in FIG. 1.

FIG. 6 is a plan view showing a configuration of an inner electrode layer of the multilayer ceramic capacitor according to the first example embodiment of the present invention, corresponding to a cross-sectional view taken along line VI-VI in FIG. 4.

FIG. 7 is a side view showing a configuration near an outer electrode of the multilayer ceramic capacitor according to the first example embodiment of the present invention, corresponding to region R in FIG. 4.

FIG. 8 is a side view showing another example of the configuration near the outer electrode of the multilayer ceramic capacitor according to the first example embodiment of the present invention, corresponding to region R in FIG. 4.

FIG. 9 is a cross-sectional view showing a configuration near an outer electrode of the multilayer ceramic capacitor according to the first example embodiment of the present invention, corresponding to region R in FIG. 4.

FIG. 10 is a cross-sectional view showing another example of the configuration near the outer electrode of the multilayer ceramic capacitor according to the first example embodiment of the present invention, corresponding to region R in FIG. 4.

FIG. 11 is a front view showing the multilayer ceramic capacitor according to Modified Example 1 of the first example embodiment of the present invention.

FIG. 12 is a side view showing the multilayer ceramic capacitor according to Modified Example 2 of the first example embodiment of the present invention.

FIG. 13 is a side view showing the multilayer ceramic capacitor according to Modified Example 2 of the first example embodiment of the present invention.

FIG. 14 is a view for describing an example of a method for manufacturing a multilayer ceramic capacitor according to an example embodiment of the present invention.

FIG. 15 is a view for describing an example of a method for manufacturing a multilayer ceramic capacitor according to an example embodiment of the present invention.

FIG. 16 is a view for describing an example of a method for manufacturing a multilayer ceramic capacitor according to an example embodiment of the present invention.

FIG. 17 is an external perspective view showing a multilayer ceramic capacitor according to a second example embodiment of the present invention.

FIG. 18 is a cross-sectional view taken along line XVIII-XVIII according to FIG. 17.

FIG. 19 is an external perspective view showing a multilayer ceramic capacitor according to a third example embodiment of the present invention.

FIG. 20 is a cross-sectional view taken along line XX-XX according to FIG. 19.

### DETAILED DESCRIPTION OF THE EXAMPLE EMBODIMENTS

Example embodiments of the present invention will be described in detail below with reference to the drawings.

### A. First Example Embodiment

### 1. Multilayer Ceramic Capacitor

As a multilayer ceramic capacitor according to an example embodiment of the present invention, a two-terminal multilayer ceramic capacitor 10 will be described.

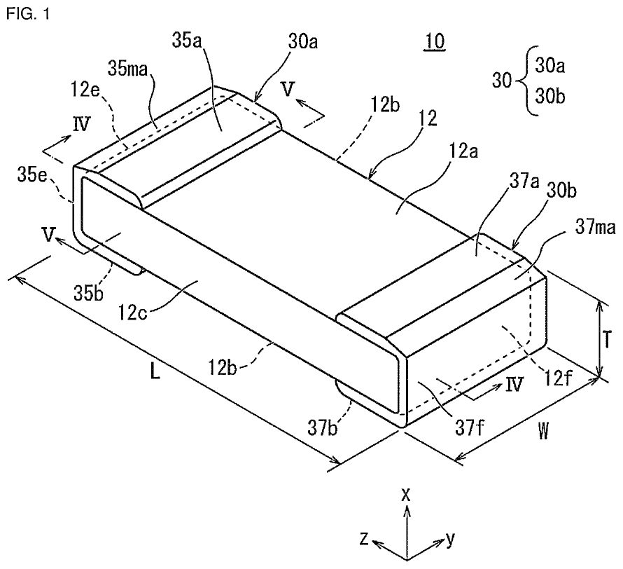

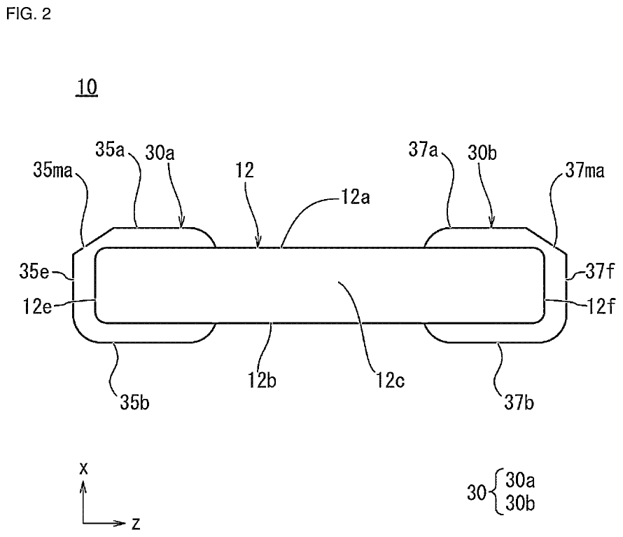

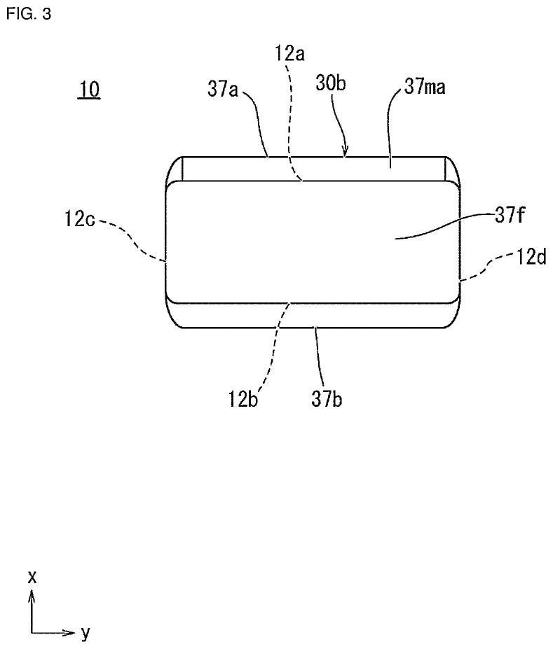

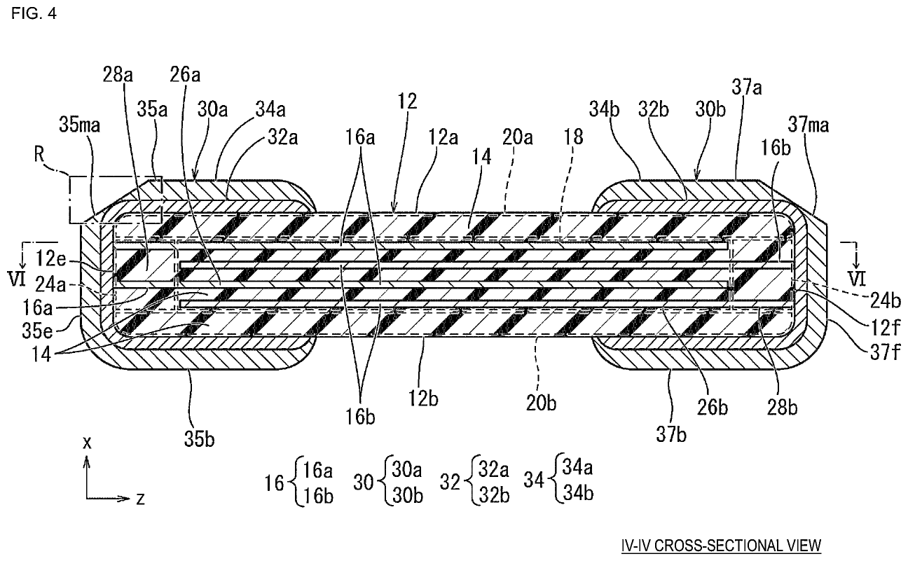

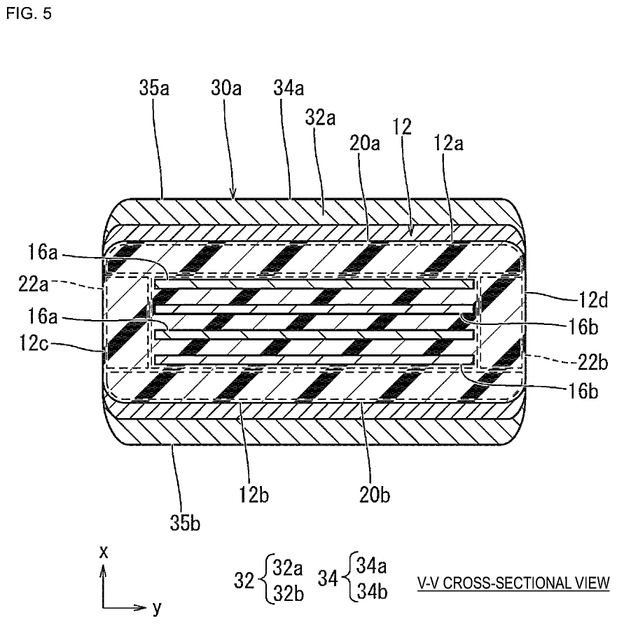

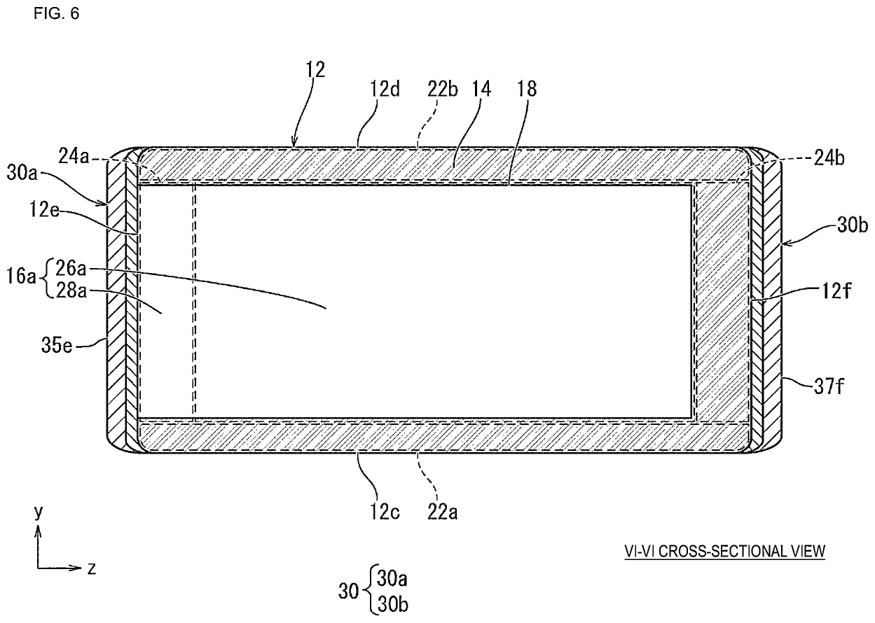

FIG. 1 is an external perspective view showing a multilayer ceramic capacitor according to a first example embodiment of the present invention. FIG. 2 is a front view showing the multilayer ceramic capacitor according to the first example embodiment of the present invention. FIG. 3 is a side view showing the multilayer ceramic capacitor according to the first example embodiment of the present invention. FIG. 4 is a cross-sectional view taken along line IV-IV in FIG. 1. FIG. 5 is a cross-sectional view taken along line V-V in FIG. 1. FIG. 6 is a plan view showing a configuration of an inner electrode layer of the multilayer ceramic capacitor according to the first example embodiment of the present invention, corresponding to a cross-sectional view taken along line VI-VI in FIG. 4.

As shown in FIGS. 1 to 4, the multilayer ceramic capacitor 10 includes a multilayer body 12 and an outer electrode 30 disposed on a surface of the multilayer body 12.

The multilayer body 12 has a rectangular or substantially a rectangular parallelepiped outer shape. The multilayer body 12 may include sharp corners at a corner portion and a ridge portion, or may be rounded. The corner portion is a portion where three adjacent surfaces of the multilayer body 12 intersect, and the ridge portion is a portion where two adjacent surfaces of the multilayer body 12 intersect.

The multilayer body 12 includes a first main surface 12a and a second main surface 12b that face each other, a first side surface 12c and a second side surface 12d that face each other while connecting the first main surface 12a and the second main surface 12b, and a first end surface 12e and a second end surface 12f that face each other in a direction orthogonal or substantially orthogonal to the first side surface 12c and the second side surface 12d while connecting the first main surface 12a and the second main surface 12b.

The first main surface 12a and the second main surface 12b, the first side surface 12c and the second side surface 12d, and the first end surface 12e and the second end surface 12f may have irregularities provided on all or a portion of them.

Here, the direction connecting the first main surface 12a and the second main surface 12b of the multilayer body 12 is defined as a height direction x, the direction connecting the first side surface 12c and the second side surface 12d among the directions orthogonal or substantially orthogonal to the height direction x is defined as a width direction y, and the direction connecting the first end surface 12e and the second end surface 12f, which are orthogonal or substantially orthogonal to the height direction x and the width direction y, is defined as a length direction z. In the following description, regarding the multilayer ceramic capacitor 10 including the multilayer body 12 and the outer electrode 30 to be described later, the dimension in the length direction z is called an L dimension, the dimension in the height direction x is called a T dimension, and the dimension in the width direction y is called a W dimension, respectively. These terms will be used in the following description.

As particularly shown in FIGS. 4 and 5, the multilayer body 12 includes a plurality of stacked ceramic layers 14 and a plurality of inner electrode layers 16 that are arranged to face each other and be spaced apart from each other inside the plurality of stacked and integrated ceramic layers 14. Each of the plurality of inner electrode layers 16 is individually disposed on each of the plurality of ceramic layers 14. Therefore, each of the plurality of inner electrode layers 16 is disposed between each of the plurality of stacked ceramic layers 14.

In the multilayer body 12, the plurality of ceramic layers 14 and the plurality of inner electrode layers 16 are arranged and stacked along the height direction x.

The multilayer body 12 includes an inner layer portion 18 in which the plurality of inner electrode layers 16 face each other in the stacking direction connecting the first main surface 12a and the second main surface 12b, a first main surface side outer layer portion 20a located between an electrode layer closest to the first main surface 12a among the plurality of inner electrode layers 16 and the first main surface 12a, and a second main surface side outer layer portion 20b located between an electrode layer closest to the second main surface 12b among the plurality of inner electrode layers 16 and the second main surface 12b.

The inner electrode layer 16 includes a first inner electrode layer 16a extending to the first end surface 12e, and a second inner electrode layer 16b extending to the second end surface 12f. The plurality of first inner electrode layers 16a and second inner electrode layers 16b face each other with the ceramic layer 14 interposed therebetween in the inner layer portion 18, thus defining and functioning as a main body portion of a capacitor that stores charge.

The first main surface side outer layer portion 20a is an aggregate of a plurality of ceramic layers 14 located between an electrode layer closest to the first main surface 12a among the plurality of inner electrode layers 16 and the first main surface 12a.

The second main surface side outer layer portion 20b is an aggregate of a plurality of ceramic layers 14 located between an electrode layer closest to the second main surface 12b among the plurality of inner electrode layers 16 and the second main surface 12b.

The inner layer portion 18 is a region sandwiched between the first main surface side outer layer portion 20a and the second main surface side outer layer portion 20b.

The multilayer body 12 includes a first side surface side outer layer portion 22a located between the inner layer portion 18 and the first side surface 12c and a second side surface side outer layer portion 22b located between the inner layer portion 18 and the second side surface 12d. These side surface side outer layer portions are also referred to as W gaps.

The first side surface side outer layer portion 22a is located on the first side surface 12c side, and is an aggregate of a plurality of ceramic layers 14 located between the first side surface 12c and the outermost surface of the inner layer portion 18 on the first side surface 12c side.

The second side surface side outer layer portion 22b is located on the second side surface 12d side, and is an aggregate of a plurality of ceramic layers 14 located between the second side surface 12d and the outermost surface of the inner layer portion 18 on the second side surface 12d side.

The multilayer body 12 includes a first end surface side outer layer portion 24a located between the inner layer portion 18 and the first side surface 12d, and a second end surface side outer layer portion 24b located between the inner layer portion 18 and the second end surface 12f. These end surface side outer layer portions are also referred to as L gaps.

The first end surface side outer layer portion 24a is located on the first end surface 12e side, and is an aggregate of a plurality of ceramic layers 14 located between the first end surface 12e and the outermost surface of the inner layer portion 18 on the first end surface 12e side and extended electrode portions of the plurality of first inner electrode layers 16a.

The second end surface side outer layer portion 24b is located on the second end surface 12f side, and is an aggregate of a plurality of ceramic layers 14 located between the second end surface 12f and the outermost surface of the inner layer portion 18 on the second end surface 12f side and extended electrode portions of the plurality of second inner electrode layers 16b.

The dimensions of the multilayer body 12 are not particularly limited.

For the ceramic layer 14, for example, a dielectric ceramic mainly including BaTiO₃, CaTio₃, SrTiO₃, or CaZro₃ can be used as the ceramic material. Further, a material in which a subcomponent such as, for example, a Mn compound, an Fe compound, a Cr compound, a Co compound, or a Ni compound, which is included to lesser amount than the main component, is added to these main components may be used.

In addition, when a piezoelectric ceramic is used for the multilayer body 12, the multilayer ceramic electronic component defines and functions as a ceramic piezoelectric element. Specific examples of piezoelectric ceramic materials include, for example, PZT (lead zirconate titanate) ceramic materials. Further, when a semiconductor ceramic is used for the multilayer body 12, the multilayer ceramic electronic component defines and functions as a thermistor element. Specific examples of semiconductor ceramic materials include, for example, spinel-based ceramic materials. Further, when a magnetic ceramic is used for the multilayer body 12, the multilayer ceramic electronic component defines and functions as an inductor element. Furthermore, when defining and functioning as an inductor element, the inner electrode layer is a coiled conductor. Specific examples of the magnetic ceramic material include, for example, ferrite ceramic materials.

It is preferable that the thickness of the ceramic layer 14 in the multilayer body 12 after firing is, for example, about 0.4 μm or more and about 5.0 μm or less.

The number of stacked ceramic layers 14 is, for example, preferably 10 or more and 700 or less. Here, the number of ceramic layers 14 is the total number of the number of ceramic layers 14 constituting the inner layer portion 18 and the number of ceramic layers 14 of the first main surface side outer layer portion 20a and the second main surface side outer layer portion 20b.

The multilayer body 12 includes a plurality of first inner electrode layers 16a and a plurality of second inner electrode layers 16b as the plurality of inner electrode layers 16. The plurality of first inner electrode layers 16a and the plurality of second inner electrode layers 16b are parallel or substantially parallel to the first main surface 12a and the second main surface 12b, and are buried to be disposed alternately along the height direction x of the multilayer body 12 with the ceramic layer 14 interposed therebetween.

In each drawing, for the sake of simplicity, it is assumed that the plurality of first inner electrode layers 16a include two first inner electrode layers 16a arranged from top to bottom along the height direction x, and the plurality of second inner electrode layers 16b include two second inner electrode layers 16b arranged from top to bottom along the height direction x. However, these are examples, and the number of first inner electrode layers 16a and second inner electrode layers 16b may be any number other than the example described below.

The first inner electrode layer 16a and the second inner electrode layer 16b are disposed on each of the plurality of ceramic layers 14 and located inside the multilayer body 12.

Hereinafter, the configuration of the inner electrode layer 16 will be described by taking the first inner electrode layer 16a as an example. As shown in FIG. 6, it is preferable that the first inner electrode layer 16a has a rectangular or substantially rectangular shape when viewed in the height direction x. Specifically, the first inner electrode layer 16a has a rectangular or substantially rectangular shape with a long side along the length direction z and a short side along the width direction y.

The first inner electrode layer 16a includes a first counter electrode portion 26a that is not exposed from the surface of the multilayer body 12 and faces the second inner electrode layer 16b, and a first extended electrode portion 28a that is located on one end side of the first inner electrode layer 16a along the length direction z, and extends from the first counter electrode portion 26a, extends to the surface of the first end surface 12e of the multilayer body 12, and is exposed from the multilayer body 12.

It is preferable that the first counter electrode portion 26a of the first inner electrode layer 16a has a rectangular or substantially rectangular shape when viewed in the height direction x. However, the corner portion may be rounded when viewed in the height direction x, or the corner portion may be provided obliquely when viewed in the height direction x (tapered shape). Alternatively, it may be tapered when viewed in the height direction x, with an inclination toward any direction along the length direction z.

It is also preferable that the first extended electrode portion 28a of the first inner electrode layer 16a has a rectangular or substantially rectangular shape when viewed in the height direction x. However, the corner portion may be rounded when viewed in the height direction x, or the corner portion may be provided obliquely when viewed in the height direction x (tapered shape). Alternatively, it may be tapered when viewed in the height direction x, with an inclination toward any direction along the length direction z.

The W dimension of the first counter electrode portion 26a of the first inner electrode layer 16a and the W dimension of the first extended electrode portion 28a may be the same or substantially the same as shown in the drawing, or one of them may be smaller than the other.

For example, the first inner electrode layer 16a of the inner electrode layer 16 can be made of an appropriate conductive material, such as a metal such as Ni, Cu, Ag, Pd, or Au, or an alloy including at least one of these metals, such as an Ag—Pd alloy, but is not limited thereto.

In the multilayer body 12, the first inner electrode layer 16a and the second inner electrode layer 16b are provided line-symmetrically with respect to the inner layer portion 18 in the height direction x, as shown in FIGS. 4 to 6. Therefore, various aspects of the configuration and shape when viewed in the height direction x of the first inner electrode layer 16a described above similarly apply to the second inner electrode layer 16b reversed in the length direction z.

Specifically, the second inner electrode layer 16b has a rectangular or substantially rectangular shape with a long side along the length direction z and a short side along the width direction y.

The second inner electrode layer 16b includes a second counter electrode portion 26b that is not exposed from the surface of the multilayer body 12 and faces the first inner electrode layer 16a, and a second extended electrode portion 28b that is located on one end side of the second inner electrode layer 16b along the length direction z, and extends from the second counter electrode portion 26b, is drawn out to the surface of the second end surface 12f of the multilayer body 12, and is exposed from the multilayer body 12.

It is preferable that the second counter electrode portion 26b of the second inner electrode layer 16b has a rectangular or substantially rectangular shape when viewed in the height direction x. However, the corner portion may be rounded when viewed in the height direction x, or the corner portion may be formed obliquely when viewed in the height direction x (tapered shape). Alternatively, it may be tapered when viewed in the height direction x, with an inclination toward any direction along the length direction z.

It is also preferable that the second extended electrode portion 28b of the second inner electrode layer 16b has a rectangular or substantially rectangular shape when viewed in the height direction x. However, the corner portion may be rounded when viewed in the height direction x, or the corner portion may be provided obliquely when viewed in the height direction x (tapered shape). Alternatively, it may be tapered when viewed in the height direction x, with an inclination toward any direction along the length direction z.

The W dimension of the second counter electrode portion 26b of the second inner electrode layer 16b and the W dimension of the second extended electrode portion 28b may be the same or substantially the same as shown in the drawing, or one of them may be smaller than the other.

In the present example embodiment, in the inner electrode layer 16, a capacitance is generated by the first counter electrode portion 26a and the second counter electrode portion 26b of the inner electrodes of the first inner electrode layer 16a and the second inner electrode layer 16b facing each other with the ceramic layer 14 interposed therebetween, and the characteristics of a capacitor are provided.

It is preferable that the thickness of each of the first inner electrode layer 16a and the second inner electrode layer 16b is not particularly limited, but is about 0.2 μm or more and about 2.0 μm or less, for example.

The number of each of the first inner electrode layer 16a and the second inner electrode layer 16b is not particularly limited, but is, for example, preferably 10 or more and 700 or less in total.

The outer electrode 30 includes a first outer electrode 30a and a second outer electrode 30b, which are two independent electrodes that are not connected to the same inner electrode layer 16.

The external configuration of the outer electrode 30 will be described below.

It is preferable that the first outer electrode 30a is electrically connected to the first inner electrode layer 16a and disposed on the first end surface 12e, a portion of the first main surface 12a, and a portion of the second main surface 12b. More specifically, the first outer electrode 30a includes a first end surface exposed portion 35e disposed on the surface of the first end surface 12e of the multilayer body 12. It is preferable that the first outer electrode 30a further includes a first main surface exposed portion 35a extending along a contour of the multilayer body 12 from the first end surface 12e with a first main surface inclined portion 35ma, which will be described later, interposed therebetween and covering a portion of the first main surface 12a, and a third main surface exposed portion 35b extending along the contour of the multilayer body 12 from the first end surface 12e and covering a portion of the second main surface 12b. The first outer electrode 30a may be disposed only on the first end surface 12e and only on a portion of the first main surface 12a or a portion of the second main surface 12b. Further, the first outer electrode 30a may be disposed to slightly wrap around from the first end surface 12e to a portion of the first side surface 12c and a portion of the second side surface 12d.

It is preferable that the second outer electrode 30b is electrically connected to the second inner electrode layer 16b and disposed on the second end surface 12f, a portion of the first main surface 12a, and a portion of the second main surface 12b. More specifically, the second outer electrode 30b includes a second end surface exposed portion 37f disposed on the surface of the second end surface 12f of the multilayer body 12. It is preferable that the second outer electrode 30b further includes a second main surface exposed portion 37a extending along the contour of the multilayer body 12 from the second end surface 12f with a second main surface inclined portion 37ma, which will be described later, interposed therebetween and covering a portion of the first main surface 12a, and a fourth main surface exposed portion 37b extending along the contour of the multilayer body 12 from the second end surface 12f and covering a portion of the second main surface 12b. The second outer electrode 30b may be disposed only on the second end surface 12f and only on a portion of the first main surface 12a or a portion of the second main surface 12b. Further, the second outer electrode 30b may be disposed to slightly wrap around from the second end surface 12f to a portion of the first side surface 12c and a portion of the second side surface 12d.

Furthermore, the first outer electrode 30a of the outer electrode 30 includes a first main surface inclined portion 35ma provided from the first main surface 12a of the multilayer body 12 to the first end surface 12e.

The first main surface inclined portion 35ma is located between the first main surface exposed portion 35a and the first end surface exposed portion 35e of the first outer electrode 30a, and is a plane to be bent with respect to each of the first main surface exposed portion 35a and the first end surface exposed portion 35e. It is preferable that the first main surface inclined portion 35ma is provided to cover the ridge portion of the multilayer body 12. That is, it is preferable that the first main surface inclined portion 35ma is provided not to intersect with the multilayer body 12 and not to expose the surface of the multilayer body 12 on the first main surface inclined portion 35ma.

Similarly, the second outer electrode 30b of the outer electrode 30 includes a second main surface inclined portion 37ma provided from the first main surface 12a of the multilayer body 12 to the second end surface 12f.

The second main surface inclined portion 37ma is located between the second main surface exposed portion 37a and the second end surface exposed portion 37f of the second outer electrode 30b, and is a plane to be bent with respect to each of the second main surface exposed portion 37a and the second end surface exposed portion 37f. It is preferable that the second main surface inclined portion 37ma is provided to cover the ridge portion of the multilayer body 12. That is, it is preferable that the second main surface inclined portion 37ma is provided not to intersect with the multilayer body 12 and not to expose the surface of the multilayer body 12 on the second main surface inclined portion 37ma.

Next, the internal configuration of the outer electrode 30 will be described.

It is preferable that the first outer electrode 30a of the outer electrode 30 includes a first base electrode layer 32a including a conductive metal, which is disposed on the multilayer body 12, and a first plated layer 34a disposed to cover the first base electrode layer 32a.

It is preferable that the second outer electrode 30b of the outer electrode 30 includes a second base electrode layer 32b including a conductive metal, which is disposed on the multilayer body 12, and a second plated layer 34b disposed to cover the second base electrode layer 32b.

It is preferable that the base electrode layer 32 including the first base electrode layer 32a and the second base electrode layer 32b includes at least one layer including a baked layer and/or a thin film layer. The baked layer as the base electrode layer 32 will be described below.

The baked layer is obtained by, for example, applying a conductive paste including a glass component and a metal to the multilayer body 12 and baking it. The glass component of the baked layer includes, for example, at least one of B, Si, Ba, Mg, Al, Li, and the like. The metal of the baked layer includes, for example, at least one of Cu, Ni, Ag, Pd, an Ag—Pd alloy, Au, and the like.

The baked layer may be obtained by, for example, simultaneously firing a multilayer chip having the inner electrode layer 16 and the ceramic layer 14, which is the base of the multilayer body 12, and a conductive paste applied to the multilayer chip. Alternatively, the baked layer may be obtained by, for example, firing the multilayer chips to obtain the multilayer body 12, and then applying a conductive paste to the multilayer body 12 and baking it. Further, the baked layer may include a single layer or a plurality of layers.

When the first base electrode layer 32a and the second base electrode layer 32b of the base electrode layer 32 are configured as baked layers, it is preferable that the thickness of each of the first end surface exposed portion 35e and the second end surface exposed portion 37f is about 1 μm or more and about 11 μm or less, for example. Moreover, it is preferable that the thickness of each of the first main surface exposed portion 35a and the second main surface exposed portion 37a is, for example, about 1 μm or more and about 11 μm or less. For each of the first outer electrode 30a and the second outer electrode 30b, when there is a portion that wraps around from the first end surface 12e to a portion of the first side surface 12c and a portion of the second side surface 12d and there is a portion that wraps around from the second end surface 12f to a portion of the first side surface 12c and a portion of the second side surface 12d, the thickness of each of the portions is preferably, for example, about 1 μm or more and about 11 μm or less.

Here, the thickness of the baked layer is the thickness at the central portion in the height direction x in the case of the first end surface exposed portion 35e and the second end surface exposed portion 37f, and the thickness at the central portion in the length direction z in the case of the first main surface exposed portion 35a and the second main surface exposed portion 37a, and for each of the first outer electrode 30a and the second outer electrode 30b, when there is a portion that wraps around from the first end surface 12e to a portion of the first side surface 12c and a portion of the second side surface 12d and there is a portion that wraps around from the second end surface 12f to a portion of the first side surface 12c and a portion of the second side surface 12d, in the case of the portions, the thickness of the baked layer is the thickness at the central portion in the width direction y.

Next, a thin film layer as the base electrode layer 32 will be described. When the base electrode layer 32 is provided as a thin film layer, the thin film layer is provided as a layer having, for example, an average thickness of about 1 μm or less by depositing metal particles.

Next, a plated layer 34 will be described. The plated layer 34 includes a first plated layer 34a on the first outer electrode 30a and a second plated layer 34b on the second outer electrode 30b. As particularly shown in FIGS. 4 and 5, the plated layer 34 preferably covers the entire or substantially the entire surface so that the base electrode layer 32 is not exposed to the outside. Specifically, the first plated layer 34a is preferably provided from a portion corresponding to the first end surface exposed portion 35e of the first base electrode layer 32a to a portion corresponding to the first main surface exposed portion 35a and the third main surface exposed portion 35b. Similarly, the second plated layer 34b is preferably provided from a portion corresponding to the second end surface exposed portion 37f of the second base electrode layer 32b to a portion corresponding to the second main surface exposed portion 37a and the fourth main surface exposed portion 37b.

The plated layer 34 includes, for example, at least one metal of Cu, Ni, Sn, Ag, Pd, an Ag—Pd alloy, Au, and the like.

The plated layer 34 may include a single layer or a plurality of layers. When the plated layer 34 includes a plurality of layers, for example, a two-layer structure of Ni plating and Sn plating is preferable.

By using the plated layer 34 made of Ni plating as the layer that is in direct contact with the base electrode layer 32, it is possible to prevent the base electrode layer 32 from being eroded by the solder used for mounting when the multilayer ceramic capacitor 10 is mounted. Furthermore, by using the plated layer 34 made of Sn plating as the upper layer of the plated layer 34 made of Ni plating, when mounting the multilayer ceramic capacitor 10 on a mounting substrate, the wettability of the solder used for mounting is improved and the mounting can be facilitated.

The thickness of each plated layer 34 is, for example, preferably about 1 μm or more and about 11 μm or less. By setting the thickness of each plated layer 34 to about 1 μm or more and about 11 μm or less, the first main surface inclined portion 35ma and the second main surface inclined portion 37ma can be provided without excessively increasing the dimensions of the chip.

The outer electrode 30 may include only the plated layer 34 without providing the base electrode layer 32. That is, the multilayer ceramic capacitor 10 may have a structure including a plated layer electrically connected to the first inner electrode layer 16a and a plated layer electrically connected to the second inner electrode layer 16b. In this case, by disposing a catalyst on the surface of the multilayer body 12 as a pretreatment, the outer electrode 30 can be defined by the plated layer 34 alone.

When the outer electrode 30 includes the plated layer 34 alone, it is preferable to include a lower layer plated electrode provided on the surface of the multilayer body 12 and an upper layer plated electrode provided on the surface of the lower layer plated electrode. Here, the upper layer plated electrode may be provided as necessary, and the outer electrode 30 may include only the lower layer plated electrode.

Each of the upper layer plated electrode and the lower layer plated electrode preferably includes, for example, at least one metal pf Cu, Ni, Sn, Pb, Au, Ag, Pd, Bi, or Zn, or an alloy including the metal. In particular, the lower layer plated electrode is preferably made using Ni, which has a solder barrier property that reduces or prevents erosion by the solder used for mounting, and the upper layer plated electrode is preferably made using Sn or Au, which improves the wettability of the solder used for mounting.

Further, for example, when the first inner electrode layer 16a and the second inner electrode layer 16b are made using Ni, the lower layer plated electrode is preferably made using Cu, which has good bonding properties with Ni.

The plated layer 34 disposed without providing the base electrode layer 32 includes the upper layer plated electrode as the outermost layer, but may have a configuration in which other plated electrodes are further provided on the surface of the upper layer plated electrode.

The thickness of each plated layer 34 disposed without providing the base electrode layer 32 is, for example, preferably about 2 μm or more and about 11 μm or less. Moreover, it is preferable that the plated layer 34 does not include glass. The metal ratio per unit volume of the plated layer 34 is, for example, preferably about 99% by volume or more.

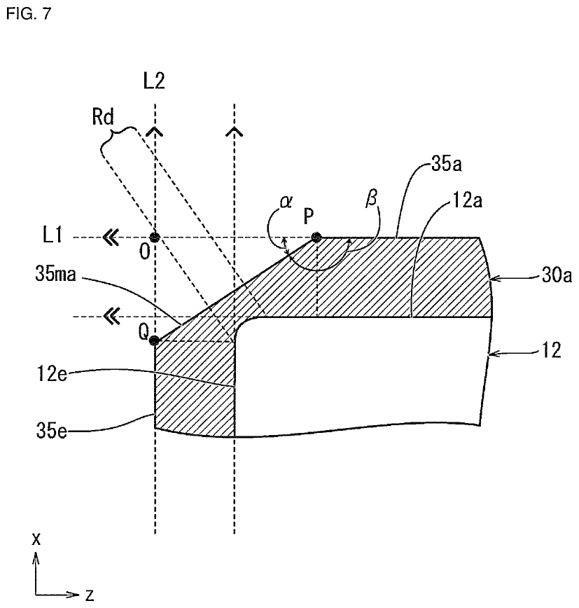

With the multilayer ceramic capacitor 10 according to the present example embodiment, in the outer electrode 30, the first outer electrode 30a includes the first main surface inclined portion 35ma, and the second outer electrode 30b includes the second main surface inclined portion 37ma, thus achieving the following advantageous effects. That is, as shown in FIG. 4 and FIG. 7, which is an enlarged view of the main portion of region R in FIG. 4, the ridge portions in the first outer electrode 30a are defined by each of the first main surface exposed portion 35a and the first main surface inclined portion 35ma, and the first end surface exposed portion 35e and the first main surface inclined portion 35ma, and these ridge portions have obtuse angles that are gentler than the right or substantially right angles of the ridge portions defined by the first main surface exposed portion 35a and the first end surface exposed portion 35e in the related art.

Accordingly, thermal stress due to solder shrinkage applied to the first outer electrode 30a is dispersed between the ridge portion defined by the first main surface exposed portion 35a and the first main surface inclined portion 35ma and the ridge portion defined by the first end surface exposed portion 35e and the first main surface inclined portion 35ma. Furthermore, since each ridge portion has an obtuse angle, it is more difficult for stress to concentrate than in the ridge portion that is provided at a right or substantially right angle in the related art. As a result, stress concentration on the boundary portion between the first main surface exposed portion 35a and the first end surface exposed portion 35e is alleviated, and cracks in the multilayer body 12 are reduced or prevented.

Therefore, the multilayer ceramic capacitor 10 does not separately provide a configuration for absorbing stress, such as a conductive resin layer, in the first outer electrode 30a, and can reduce the influence of thermal stress due to solder shrinkage while reducing or preventing an increase in the dimensions of the component.

As shown in FIG. 7, an angle β between the first main surface exposed portion 35a and the first main surface inclined portion 35ma of the first outer electrode 30a provided on the first main surface 12a side is defined as β=about 180°-α, for example, where an angle <OPQ is <OPQ=a when the intersection point of straight lines extending in parallel from each of the first main surface exposed portion 35a and the first end surface exposed portion 35e is denoted by O, the position of the ridge portion formed by the first main surface inclined portion 35ma and the first main surface exposed portion 35a is denoted by P, and the position of the ridge portion formed by the first main surface inclined portion 35ma and the first end surface exposed portion 35e is denoted by Q.

The angle β is, for example, preferably about 120° or more and about 170° or less. When the angle β is made smaller than about 120°, the intersection angle between the first main surface inclined portion 35ma and the first main surface exposed portion 35a becomes small, and thus there is a concern that the advantageous effect of reducing stress concentration at the ridge portion defined by the first main surface inclined portion 35ma and the first main surface exposed portion 35a may be impaired, or the first main surface inclined portion 35ma may intersect with the multilayer body 12 and expose its surface. When the angle β is made larger than about 170°, the intersection angle between the first main surface inclined portion 35ma and the first end surface exposed portion 35e becomes small, and thus there is a concern that the advantageous effect of reducing or preventing stress concentration at the ridge portion defined by the first main surface inclined portion 35ma and the first end surface exposed portion 35e may be impaired, or the first main surface inclined portion 35ma may intersect with the multilayer body 12 and expose its surface.

Specifically, the angle β is measured as follows, for example. The multilayer ceramic capacitor 10 is polished along the width direction y to a position where the W dimension is about ½ so that an LT cross section is exposed, the LT cross section exposed by polishing is imaged with a microscope (manufactured by Keyence Corporation, VHK series), and the imaged surface is observed using software attached to the microscope.

Based on the observation, when viewed from the LT plane, the point, which is the intersection point of the straight line extending parallel or substantially parallel to the first end surface 12e of the multilayer body 12 and the surface of the first main surface exposed portion 35a of the first outer electrode 30a that is at the farthest position from the surface of the multilayer body 12 along the height direction x and is at the closest position to the first end surface 12e, is defined as a position P of the ridge portion defined by the first main surface inclined portion 35ma and the first main surface exposed portion 35a.

Also, the point, which is the intersection point of the straight line extending parallel or substantially parallel to the first main surface 12a of the multilayer body 12 and the surface of the first end surface exposed portion 35e that is at the farthest position from the surface of the multilayer body 12 along the length direction z and is at the closest position to the first main surface 12a, is defined as a position Q of the ridge portion formed by the first main surface inclined portion 35ma and the first end surface exposed portion 35e.

Further, the intersection point of a straight parallel line L1 passing through point P and extending parallel or substantially parallel to the first main surface 12a and a straight parallel line L2 passing through point Q and extending parallel or substantially parallel to the first end surface 12e is defined as an intersection point O of straight lines extending in parallel or substantially parallel from each of the first main surface exposed portion 35a and the first end surface exposed portion 35e.

Thus, the line connecting point P and point Q is observed as the first main surface inclined portion 35ma on the LT plane, <OPQ is measured as the angle x as an actual value, and the angle β is calculated.

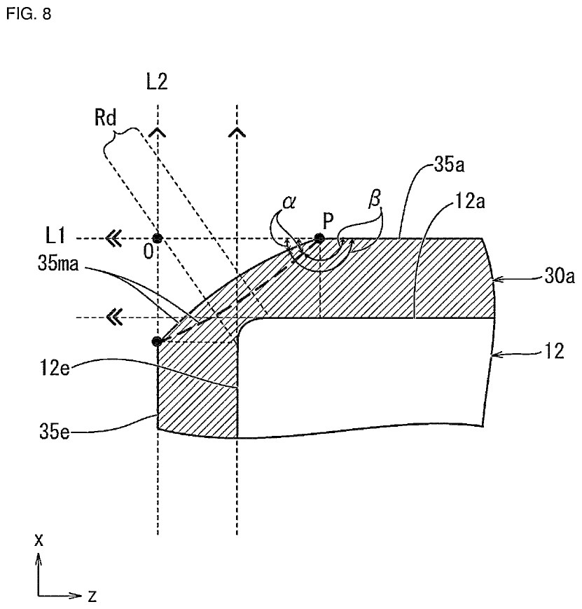

In the above description, the first main surface inclined portion 35ma is a completely flat surface, that is, a straight line when viewed from the LT plane, but the first main surface inclined portion 35ma does not need to be a completely flat surface. That is, it does not have to be a straight line when viewed from the LT plane. FIG. 8 is an example in which the first main surface inclined portion 35ma is a curved surface. In FIG. 8, the solid line is an example of a curved surface convexly curved upward, and the long broken line is an example of a curved surface curved convexly downwardly.

Further, for example, in this case, it is preferable that the radius of curvature of the first main surface inclined portion 35ma is in the range of about 50 μm to ∞. When the radius of curvature is within this range, the first main surface inclined portion 35ma is favorably provided, and a sufficient stress dispersion effect can be obtained in the ridge portion defined by the first main surface exposed portion 35a and the first main surface inclined portion 35ma and the ridge portion defined by the first end surface exposed portion 35e and the first main surface inclined portion 35ma.

Further, in the above description, points P, Q, and O used for the evaluation of the position, range, and angle β of the first main surface inclined portion 35ma in the first outer electrode 30a were provided on the LT plane which is the same plane, and straight lines passing through each of points P, Q, and O were orthogonal or substantially orthogonal to each other. However, these straight lines may be observed and measured so that they are not orthogonal or substantially orthogonal to each other. The same applies to the evaluation of the position, range, and angle β of the second main surface inclined portion 37ma in the second outer electrode 30b.

Next, the internal configuration near the first main surface inclined portion 35ma will be described.

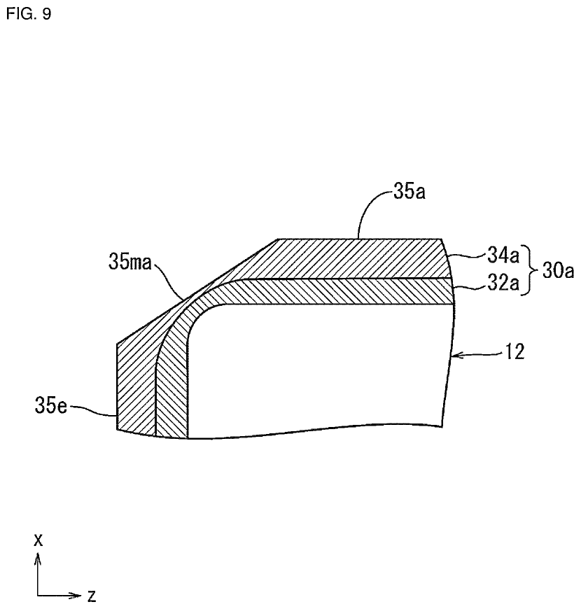

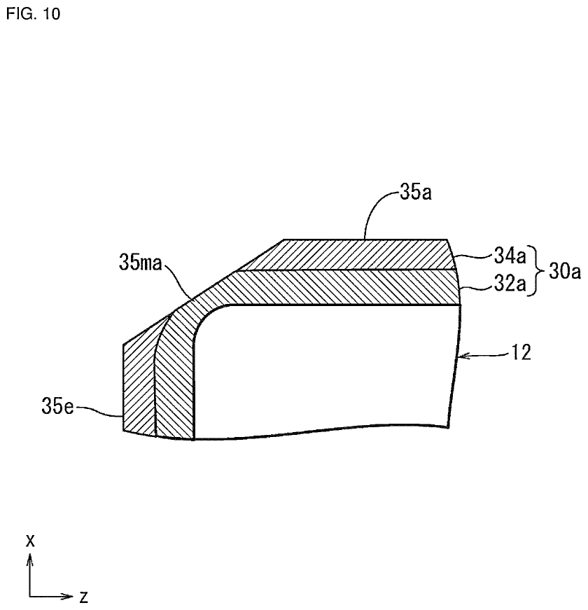

The first main surface inclined portion 35ma may be configured as a surface provided on the first plated layer 34a as shown in FIGS. 4 and 9, or as shown in FIG. 10, it may be configured as a surface formed across both the first base electrode layer 32a and the first plated layer 34a. When the first outer electrode 30a includes only the plated layer 34, the first main surface inclined portion 35ma is a surface formed on the plated layer 34.

In particular, by providing the first main surface inclined portion 35ma across both the first base electrode layer 32a and the first plated layer 34a, it becomes possible to more effectively reduce or prevent cracks in the multilayer body 12 and more effectively reduce or prevent the influence of thermal stress caused by solder shrinkage.

In the above description, the first main surface inclined portion 35ma of the first outer electrode 30a was taken as an example, but the second main surface inclined portion 37ma of the second outer electrode 30b shown in FIGS. 1 and 4 also has the same or substantially the same configuration as the first main surface inclined portion 35ma, and various descriptions with reference to FIGS. 7 to 10 apply. In this case, the first main surface inclined portion 35ma and the second main surface inclined portion 37ma may have the same or substantially the same shape or may have mutually different shapes.

As for the dimensions of the multilayer ceramic capacitor 10 of the present example embodiment, for example, it is preferable that the L dimension is about 0.1 mm or more and about 6.0 mm or less. It is preferable that the T dimension is, for example, about 10 μm or more and about 300 μm or less, and further, it is preferable that the T dimension is set to about 10 μm or more and about 300 μm or less because the advantageous effect of the configuration provided with the main surface inclined portion and a side surface inclined portion, which will be described later, can be more clearly exhibited. It is preferable that the W dimension is, for example, about 0.1 mm or more and about 6.0 mm or less.

### Modified Example 1 of First Example Embodiment

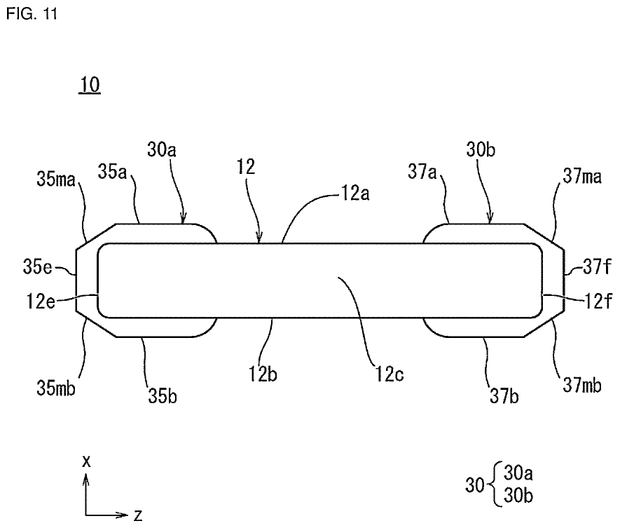

Next, with reference to FIG. 11, a Modified Example 1 of the multilayer ceramic capacitor 10 according to the first example embodiment will be described. In Modified Example 1 shown in FIG. 11, in the outer electrode 30, the first outer electrode 30a further includes a third main surface inclined portion 35mb, and the second outer electrode 30b further includes a fourth main surface inclined portion 37mb. The third main surface inclined portion 35mb extends from the second main surface 12b of the multilayer body 12 to the first end surface 12e. The fourth main surface inclined portion 37mb extends from the second main surface 12b of the multilayer body 12 to the second end surface 12f.

The third main surface inclined portion 35mb is located between the third main surface exposed portion 35b and the first end surface exposed portion 35e of the first outer electrode 30a, and is a plane bent with respect to each of the third main surface exposed portion 35b and the first end surface exposed portion 35e. It is preferable that the third main surface inclined portion 35mb covers the ridge portion of the multilayer body 12. That is, it is preferable that the third main surface inclined portion 35mb does not intersect with the multilayer body 12 and does not expose the surface of the multilayer body 12 on the third main surface inclined portion 35mb.

The fourth main surface inclined portion 37mb is located between the fourth main surface exposed portion 37b and the second end surface exposed portion 37f of the second outer electrode 30b, and is a plane bent with respect to each of the fourth main surface exposed portion 37b and the second end surface exposed portion 37f. It is preferable that the fourth main surface inclined portion 37mb covers the ridge portion of the multilayer body 12. That is, it is preferable that the fourth main surface inclined portion 37mb does not intersect with the multilayer body 12 and does not expose the surface of the multilayer body 12 on the fourth main surface inclined portion 37mb.

The detailed configurations of the third main surface inclined portion 35mb and the fourth main surface inclined portion 37mb are the same as or similar to those of the first main surface inclined portion 35ma and the second main surface inclined portion 37ma, and the various descriptions with reference to FIGS. 7 to 10 apply. In this case, the third main surface inclined portion 35mb and the fourth main surface inclined portion 37mb may have the same or substantially the same shape or may have mutually different shapes.

According to Modified Example 1, thermal stress due to solder shrinkage applied to the first outer electrode 30a is concentrated on the third main surface inclined portion 35mb rather than on each of the first end surface exposed portion 35e and the third main surface exposed portion 35b. As a result, the stress concentration on the bonding portion between the first outer electrode 30a and the multilayer body 12 in the first main surface exposed portion 35a is alleviated, and cracks in the multilayer body 12 are reduced or prevented.

Similarly, thermal stress due to solder shrinkage applied to the second outer electrode 30b is concentrated on the fourth main surface inclined portion 37mb rather than on each of the first end surface exposed portion 35e and the fourth main surface exposed portion 37b. As a result, the stress concentration on the bonding portion between the second outer electrode 30b and the multilayer body 12 in the first main surface exposed portion 35a is alleviated, and cracks in the multilayer body 12 are reduced or prevented.

Therefore, the multilayer ceramic capacitor 10 does not separately provide a configuration for absorbing stress, such as a conductive resin layer, in the outer electrode 30, and can reduce the influence of thermal stress due to solder shrinkage while reducing or preventing an increase in the dimensions of the component.

### Modified Example 2 of First Example Embodiment

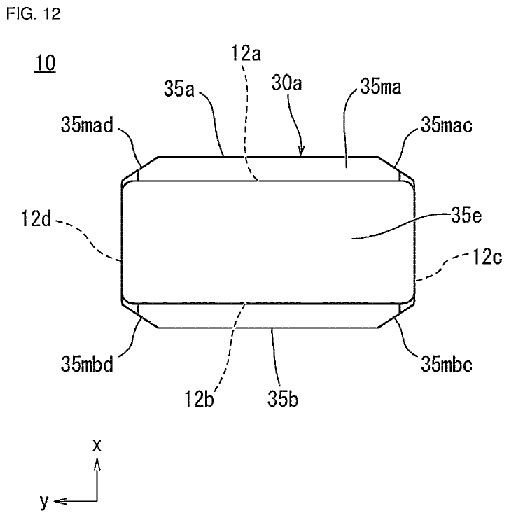

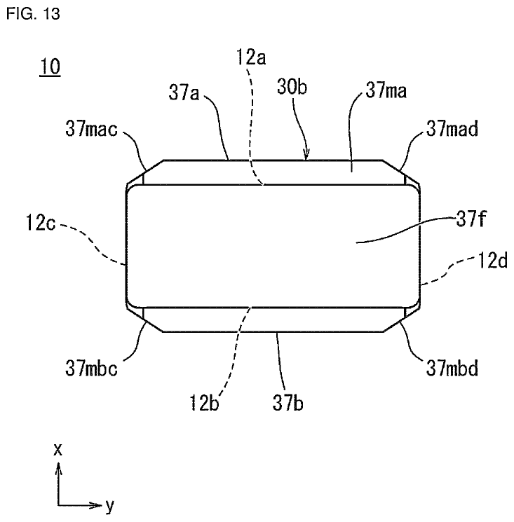

Next, with reference to FIGS. 12 and 13, Modified Example 2 of the multilayer ceramic capacitor 10 of the first example embodiment will be described. In Modified Example 2 shown in FIGS. 12 and 13, the first outer electrode 30a of the outer electrode 30 further includes a first side surface inclined portion 35mac extending from the first main surface 12a of the multilayer body 12 to the first side surface 12c, and a second side surface inclined portion 35mad extending from the first main surface 12a of the multilayer body 12 to the second side surface 12d.

The first side surface inclined portion 35mac is located at the edge end of the first main surface exposed portion 35a of the first outer electrode 30a along the length direction z on the first side surface 12c side of the multilayer body 12, and is a plane bent with respect to the first main surface exposed portion 35a. It is preferable that the first side surface inclined portion 35mac covers the ridge portion of the multilayer body 12. That is, it is preferable that the first side surface inclined portion 35mac does not intersect with the multilayer body 12 and does not expose the surface of the multilayer body 12 on the first side surface inclined portion 35mac.

The second side surface inclined portion 35mad is located at the edge end of the first main surface exposed portion 35a of the first outer electrode 30a along the length direction z on the second side surface 12d side of the multilayer body 12, and is a plane bent with respect to the first main surface exposed portion 35a. It is preferable that the second side surface inclined portion 35mad covers the ridge portion of the multilayer body 12. That is, it is preferable that the second side surface inclined portion 35mad does not intersect with the multilayer body 12 and does not expose the surface of the multilayer body 12 on the second side surface inclined portion 35mad.

The detailed configurations of the first side surface inclined portion 35mac and the second side surface inclined portion 35mad are the same as or similar to those of the first main surface inclined portion 35ma and the second main surface inclined portion 37ma, and the various descriptions with reference to FIGS. 7 to 10 in place of the WT plane apply. Therefore, it is preferable that the angle between the first main surface exposed portion 35a and the first side surface inclined portion 35mac of the first outer electrode 30a provided on the first main surface side is, for example, about 120° or more and about 170° or less when viewed from the WT plane. Similarly, it is preferable that the angle between the first main surface exposed portion 35a and the second side surface inclined portion 35mad is, for example, about 120° or more and about 170° or less when viewed from the WT plane.

Similarly, the second outer electrode 30b of the outer electrode 30 further includes a fifth side surface inclined portion 37mac extending from the first main surface 12a of the multilayer body 12 to the first side surface 12c, and a sixth side surface inclined portion 37mad extending from the first main surface 12a of the multilayer body 12 to the second side surface 12d.

The fifth side surface inclined portion 37mac is located at the edge end of the second main surface exposed portion 37a of the second outer electrode 30b along the length direction z on the first side surface 12c side of the multilayer body 12, and is a plane bent with respect to the second main surface exposed portion 37a. It is preferable that the fifth side surface inclined portion 37mac covers the ridge portion of the multilayer body 12. That is, it is preferable that the fifth side surface inclined portion 37mac does not intersect with the multilayer body 12 and does not expose the surface of the multilayer body 12 on the fifth side surface inclined portion 37mac.

The sixth side surface inclined portion 37mad is located at the edge end of the second main surface exposed portion 37a of the second outer electrode 30b along the length direction z on the second side surface 12d side of the multilayer body 12, and is a plane bent with respect to the second main surface exposed portion 37a. It is preferable that the sixth side surface inclined portion 37mad covers the ridge portion of the multilayer body 12. That is, it is preferable that the sixth side surface inclined portion 37mad does not intersect with the multilayer body 12 and does not expose the surface of the multilayer body 12 on the six side surface inclined portion 37mad.

The detailed configurations of the fifth side surface inclined portion 37mac and the sixth side surface inclined portion 37mad are the same as or similar to those of the first main surface inclined portion 35ma and the second main surface inclined portion 37ma, and the various descriptions with reference to FIGS. 7 to 10 in place of the WT plane apply. Therefore, for example, it is preferable that the angle between the first main surface exposed portion 35a and the fifth side surface inclined portion 37mac of the first outer electrode 30a provided on the first main surface side is about 120° or more and about 170° or less when viewed from the WT plane. Similarly, for example, it is preferable that the angle between the first main surface exposed portion 35a and the sixth side surface inclined portion 37mad is about 120° or more and about 170° or less when viewed from the WT plane.

Further, in Modified Example 2, the first outer electrode 30a of the outer electrode 30 further includes a third side surface inclined portion 35mbc extending from the second main surface 12b of the multilayer body 12 to the first side surface 12c, and a fourth side surface inclined portion 35mbd extending from the first main surface 12a of the multilayer body 12 to the second side surface 12d.

The third side surface inclined portion 35mbc is located at the edge end of the third main surface exposed portion 35b of the first outer electrode 30a along the length direction z on the first side surface 12c side of the multilayer body 12, and is a plane bent with respect to the third main surface exposed portion 35b. It is preferable that the third side surface inclined portion 35mbc covers the ridge portion of the multilayer body 12. That is, it is preferable that the third side surface inclined portion 35mbc does not intersect with the multilayer body 12 and does not expose the surface of the multilayer body 12 on the third side surface inclined portion 35mbc.

The fourth side surface inclined portion 35mbd is a plane provided at the edge end of the third main surface exposed portion 35b of the first outer electrode 30a along the length direction z on the second side surface 12d side of the multilayer body 12. It is preferable that the fourth side surface inclined portion 35mbd covers the ridge portion of the multilayer body 12. That is, it is preferable that the fourth side surface inclined portion 35mbd does not intersect with the multilayer body 12 and does not expose the surface of the multilayer body 12 on the fourth side surface inclined portion 35mbd.

The detailed configurations of the third side surface inclined portion 35mbc and the fourth side surface inclined portion 35mbd are the same as or similar to those of the first main surface inclined portion 35ma and the second main surface inclined portion 37ma, and the various descriptions with reference to FIGS. 7 and 8 in place of the WT plane apply. Therefore, for example, it is preferable that the angle between the third main surface exposed portion 35b and the third side surface inclined portion 35mbc of the first outer electrode 30a provided on the second main surface side is about 120° or more and about 170° or less when viewed from the WT plane. Similarly, for example, it is preferable that the angle between the third main surface exposed portion 35b and the fourth side surface inclined portion 35mbd is about 120° or more and about 170° or less when viewed from the WT plane.

Similarly, the second outer electrode 30b of the outer electrode 30 further includes a seventh side surface inclined portion 37mbc extending from the second main surface 12b of the multilayer body 12 to the first side surface 12c, and an eighth side surface inclined portion 37mbd extending from the second main surface 12b of the multilayer body 12 to the second side surface 12d.

The seventh side surface inclined portion 37mbc is a plane provided at the edge end of the fourth main surface exposed portion 37b of the second outer electrode 30b along the length direction z on the first side surface 12c side of the multilayer body 12. It is preferable that the seventh side surface inclined portion 37mbc covers the ridge portion of the multilayer body 12. That is, it is preferable that the seventh side surface inclined portion 37mbc does not intersect with the multilayer body 12 and does not expose the surface of the multilayer body 12 on the seventh side surface inclined portion 37mbc.

The eighth side surface inclined portion 37mbd is a plane provided at the edge end of the fourth main surface exposed portion 37b of the second outer electrode 30b along the length direction z on the second side surface 12d side of the multilayer body 12. It is preferable that the eighth side surface inclined portion 37mbd covers the ridge portion of the multilayer body 12. That is, it is preferable that the eighth side surface inclined portion 37mbd does not intersect with the multilayer body 12 and does not expose the surface of the multilayer body 12 on the eighth side surface inclined portion 37mbd.

The detailed configurations of the seventh side surface inclined portion 37mbc and the eighth side surface inclined portion 37mbd are the same as or similar to those of the first main surface inclined portion 35ma and the second main surface inclined portion 37ma, and the various descriptions with reference to FIGS. 7 and 8 in place of the WT plane apply. Therefore, for example, it is preferable that the angle between the fourth main surface exposed portion 37b and the seventh side surface inclined portion 37mbc of the second outer electrode 30b provided on the second main surface side is about 120° or more and about 170° or less when viewed from the WT plane. Similarly, for example, it is preferable that the angle formed between the fourth main surface exposed portion 37b and the eighth side surface inclined portion 37mbd is about 120° or more and about 170° or less when viewed from the WT plane.

According to Modified Example 2, thermal stress due to solder shrinkage applied to the first outer electrode 30a is concentrated on each of the first side surface inclined portion 35mac, the second side surface inclined portion 35mad, the third side surface inclined portion 35mbc, and the fourth side surface inclined portion 35mbd, in addition to the first main surface inclined portion 35ma and the third main surface inclined portion 35mb. As a result, the stress concentration on the bonding portion between the first outer electrode 30a and the multilayer body 12 in the first main surface exposed portion 35a and the third main surface exposed portion 35b is further alleviated, and cracks in the multilayer body 12 are more effectively reduced or prevented.

Similarly, thermal stress due to solder shrinkage applied to the second outer electrode 30b is concentrated on each of the fifth side surface inclined portion 37mac, the sixth side surface inclined portion 37mad, the seventh side surface inclined portion 37mbc, and the eighth side surface inclined portion 37mbd, in addition to the second main surface inclined portion 37ma and the fourth main surface inclined portion 37mb. As a result, the stress concentration on the bonding portion between the second outer electrode 30b and the multilayer body 12 in the second main surface exposed portion 37a and the fourth main surface exposed portion 37b is further alleviated, and cracks in the multilayer body 12 are more effectively reduced or prevented.

Therefore, the multilayer ceramic capacitor 10 does not separately provide a configuration for absorbing stress, such as a conductive resin layer, in the outer electrode 30, and can further reduce the influence of thermal stress due to solder shrinkage while further reducing or preventing an increase in the dimensions of the component.

The first side surface inclined portion 35mac, the second side surface inclined portion 35mad, the third side surface inclined portion 35mbc, and the fourth side surface inclined portion 35mbd may all have the same or substantially the same shape or may have mutually different shapes. Similarly, the fifth side surface inclined portion 37mac, the sixth side surface inclined portion 37mad, the seventh side surface inclined portion 37mbc, and the eighth side surface inclined portion 37mbd may all have the same or substantially the same shape or may have mutually different shapes.

Also in Modified Example 2, the thickness of each plated layer 34 is, for example, preferably about 1 μm or more and about 11 μm or less. By setting the thickness of each plated layer 34 to about 1 μm or more and about 11 μm or less, the first side surface inclined portion 35mac, the second side surface inclined portion 35mad, the third side surface inclined portion 35mbc, and the fourth side surface inclined portion 35mbd of the first outer electrode 30a and the fifth side surface inclined portion 37mac, the sixth side surface inclined portion 37mad, the seventh side surface inclined portion 37mbc, and the eighth side surface inclined portion 37mbd of the second outer electrode 30b can be provided without excessively increasing the dimensions of the chip.

In addition, each of the first side surface inclined portion 35mac, the second side surface inclined portion 35mad, the third side surface inclined portion 35mbc, and the fourth side surface inclined portion 35mbd of the first outer electrode 30a and the fifth side surface inclined portion 37mac, the sixth side surface inclined portion 37mad, the seventh side surface inclined portion 37mbc, and the eighth side surface inclined portion 37mbd of the second outer electrode 30b may be configured as a surface provided on the first plated layer 34a, similarly to the first main surface inclined portion 35ma shown in FIG. 9, or may be configured as a surface provided across both the first base electrode layer 32a and the first plated layer 34a, similarly to the first main surface inclined portion 35ma shown in FIG. 10.

When the first outer electrode 30a and the second outer electrode 30b include only the plated layer 34, each of the side surface inclined portions is a surface provided on the plated layer 34. In particular, by providing each of the above-mentioned side surface inclined portions across both the first base electrode layer 32a and the first plated layer 34a, it becomes possible to more effectively reduce or prevent cracks in the multilayer body 12 and more effectively reduce or prevent the influence of thermal stress caused by solder shrinkage.

### 2. Method for Manufacturing Multilayer Ceramic Capacitor

As an example or a method for manufacturing a multilayer ceramic capacitor according to an example embodiment of the present invention, a method for manufacturing the multilayer ceramic capacitor according to the above example embodiment will be described.

### Preparation

First, a dielectric sheet for the ceramic layer 14 and a conductive paste for the inner electrode layer 16 are prepared. The dielectric sheets are prepared such that one in which the first inner electrode layer 16a is disposed, one in which the second inner electrode layer 16b is disposed, and one in which the inner electrode layer 16 is not disposed. The dielectric sheet and the conductive paste each include a binder and a solvent. Known binders and solvents can be used. The conductive paste is a paste made of a conductive material, for example, a paste in which an organic binder and an organic solvent are added to metal powder.

### Production of Multilayer Sheet

Next, an inner electrode pattern having a predetermined shape corresponding to each shape of the inner electrode layer 16 is printed on the dielectric sheet using a conductive paste, for example, through a method such as screen-printing, gravure printing, or printing using an inkjet printer. Accordingly, a conductive paste is applied to a portion of the dielectric sheet where the portion that will become the first inner electrode layer 16a is disposed to form a conductive paste layer. Hereinafter, such a dielectric sheet will be referred to as a first coated dielectric sheet. Further, a conductive paste is applied to a portion of the dielectric sheet where the second inner electrode layer 16b is disposed to form a conductive paste layer. Hereinafter, such a dielectric sheet will be referred to as a second coated dielectric sheet. Regarding the dielectric sheet, an outer layer dielectric sheet without an inner electrode pattern is also produced.

A multilayer sheet is produced using the dielectric sheet prepared as described above. That is, a predetermined number of outer layer dielectric sheets including no inner electrode pattern are stacked, and a first coated dielectric sheet and a second coated dielectric sheet are stacked thereon alternately or in a desired arrangement order. Further, a predetermined number of outer layer dielectric sheets including no inner electrode pattern are stacked thereon to produce a multilayer sheet. The order in which the respective stacking materials are produced is not limited to the above, and may be performed in any order or in parallel.

### Production of Multilayer Block

Next, the multilayer sheet is pressed in the stacking direction of the dielectric sheets by, for example, an isostatic press to produce a multilayer block.

### Production of Multilayer Chip

A plurality of multilayer chips are cut out by cutting the multilayer block to a predetermined size. At this time, the corner portions and ridge portions of the multilayer chips may be rounded by, for example, barrel polishing or the like.

### Production of Multilayer Body

The multilayer body 12 is produced by firing the multilayer chips. Although the firing temperature depends on the material of the dielectric sheet and the material of the inner electrode layer 16, it is, for example, preferably about 900° C. or more and about 1400° C. or less.

### Formation of Outer Electrode

### When Base Electrode Layer is Baked Layer

A case where the base electrode layer 32 is formed of a baked layer will be described. When forming a baked layer, conductive paste including a glass component and a metal is prepared and applied. Thereafter, a baking treatment is performed to form the base electrode layer 32.

Specifically, a conductive paste corresponding to each of the first end surface exposed portion 35e and the second end surface exposed portion 37f is applied on each of the first end surface 12e and the second end surface 12f of the multilayer body 12 and baked to form the first base electrode layer 32a of the first outer electrode 30a and the second base electrode layer 32b of the second outer electrode 30b.

Here, the method for applying the conductive paste is, for example, dipping or screen-printing. Further, for example, the temperature of the baking treatment is preferably about 700° C. or more and about 900° C. or less.

### When Base Electrode Layer is Thin Film Layer

A case where the base electrode layer 32 is formed of a thin film layer will be described. When forming a thin film layer, areas other than the desired area where the outer electrode 30 is to be formed are covered by masking or the like, and a thin film forming method such as a sputtering method or a vapor deposition method is applied to the exposed desired area. The base electrode layer 32 formed of a thin film layer is a layer with a thickness of, for example, about 1 μm or less on which metal particles are deposited.

When Base Electrode Layer is Plated layer

A case where the base electrode layer 32 is formed of a plated layer will be described. Each of the first end surface 12e and second end surface 12f of the multilayer body 12 is subjected to plating treatment, and a base plated film is formed on the externally exposed portions of the inner electrode layer 16 as the first end surface exposed portion 35e and the second end surface exposed portion 37f. In performing the plating treatment, for example, either electrolytic plating or electroless plating may be employed, but electroless plating requires pretreatment with a catalyst to improve the plating deposition rate, which has a disadvantage of complicating the process. Therefore, it is usually preferable to employ electrolytic plating. As a specific example of the plating treatment, barrel plating is preferably used.

As necessary, when the base electrode layer 32 has a configuration including a lower layer plated electrode formed on the surface of the multilayer body 12 and an upper layer plated electrode formed on the surface of the lower layer plated electrode, using the base plated film as a lower layer plated electrode, an upper layer plated electrode formed on the surface of the lower layer plated electrode is formed by the same or substantially the same plating treatment as described above.

Production of Plated layer

A plated layer 34 is formed. The plated layer 34 may be formed on each surface of the first base electrode layer 32a and the second base electrode layer 32b, or may be formed directly on the multilayer body 12. In the present example embodiment, the plated layer 34 is formed along the surface shape of each of the first base electrode layer 32a and the second base electrode layer 32b as baked layers. More specifically, for example, a Ni plated layer is formed on the first base electrode layer 32a and the second base electrode layer 32b as the first plated layer 34a and the second plated layer 34b, and a Sn plated layer is further formed on the surface thereof.

In addition, when forming the plated layer 34 directly on the multilayer body 12, it can be formed by, for example, the following method. That is, each of the first end surface 12e and second end surface 12f of the multilayer body 12 is subjected to plating treatment, and a base plated film is formed on the externally exposed portion of the inner electrode layer 16. In performing the plating treatment, either electrolytic plating or electroless plating may be employed, but electroless plating requires pretreatment with a catalyst to improve the plating deposition rate, which has a disadvantage of complicating the process. Therefore, it is usually preferable to use electrolytic plating.

In performing the plating treatment, a barrel plating method can be used.

### Formation of Inclined Portion

The inclined portions that become the first main surface inclined portion 35ma and the second main surface inclined portion 37ma are formed when the outer electrode 30 is formed. The inclined portion may be formed after the first base electrode layer 32a and the second base electrode layer 32b of the outer electrode 30 are formed and before the first plated layer 34a and the second plated layer 34b are formed, or formed after the first plated layer 34a and the second plated layer 34b are formed.

The specific method for forming the inclined portion is, for example, preferably laser processing or sandblasting.

In the following description, the formation of the first main surface inclined portion 35ma of the first outer electrode 30a will be taken as an example, but the third main surface inclined portion 35mb, the first side surface inclined portion 35mac, the second side surface inclined portion 35mad, the third side surface inclined portion 35mbc, and the fourth side surface inclined portion 35mbd of the first outer electrode 30a are also formed in the same or substantially the same manner. Further, the second main surface inclined portion 37ma, the fourth main surface inclined portion 37mb, the fifth side surface inclined portion 37mac, the sixth side surface inclined portion 37mad, the seventh side surface inclined portion 37mbc, and the eighth side surface inclined portion 37mbd of the second outer electrode 30b are also formed in the same or substantially the same manner.

### Laser Processing

First, a method for forming the inclined portion by laser processing will be described.

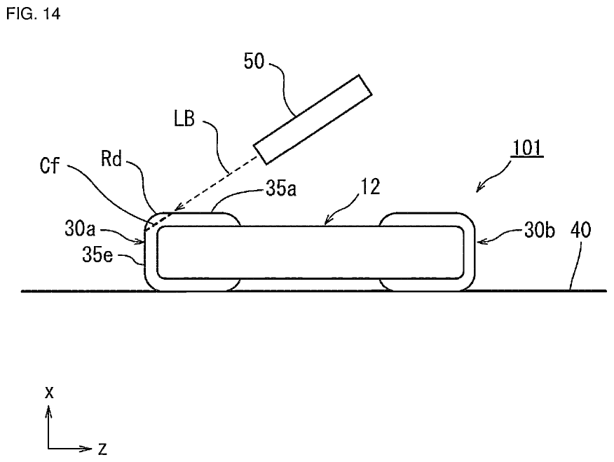

As shown in FIG. 14, a chip 101 is positioned and fixed on a chip mounting table 40. The chip 101 is a semi-finished product of the multilayer ceramic capacitor 10 in which the first outer electrode 30a and the second outer electrode 30b are formed on the multilayer body 12 after firing.

A laser beam LB is applied from the laser processing machine 50 onto a ridge portion Rd extending in the width direction y, which is formed by the first main surface exposed portion 35a and the first end surface exposed portion 35e of the first outer electrode 30a of the chip 101. Specifically, an angle x as a depression angle extending downward along the height direction x from the LW plane is set to the laser beam LB as a target angle on the LT plane, and chamfering is performed by performing scanning along the width direction y and removing the ridge portion Rd. In FIG. 14, a cut surface Cf of the first outer electrode 30a indicates the irradiation position of the ridge portion Rd by the laser beam LB. The cut surface Cf is set not to intersect the multilayer body 12.

Thus, an inclined portion is formed between the first main surface exposed portion 35a and the first end surface exposed portion 35e.

### Sandblasting

Subsequently, a method for forming the inclined portion by sandblasting will be described.

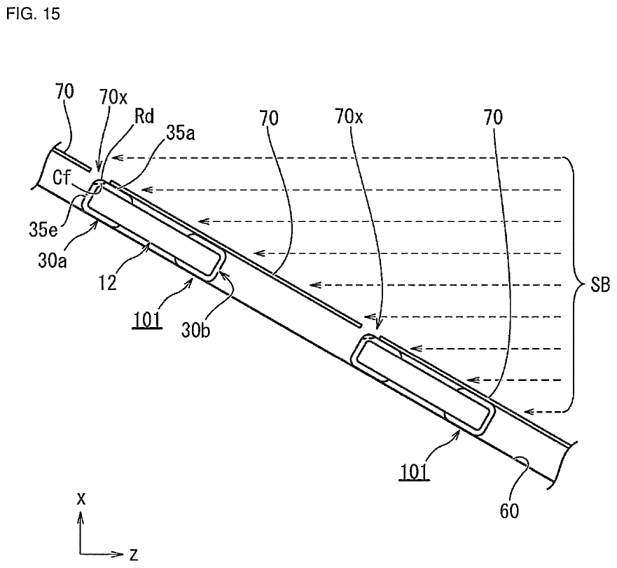

As shown in FIG. 15, one or more chips 101 are positioned and fixed on a chip support 60. The chip support 60 is inclined to have an upward elevation angle along the height direction x, corresponding to the angle α as the target angle on the LT plane of the chip 101. Thus, the cut surface Cf of the first outer electrode 30a is parallel or substantially parallel to the LW plane.

Furthermore, the surface of the fixed chip 101 is masked with a mask 70. A slit 70x having a position and shape corresponding to the position and shape of the inclined portion is open in the mask 70, and the chip 101 masked by the mask 70 is placed in a state where only the ridge portion Rd of the first outer electrode 30a is exposed with the slit 70x interposed therebetween when viewed in the length direction z.

For such a chip 101, a projection material SB is projected onto the mask 70 along a direction parallel to the LW plane, and the ridge portion Rd of the first outer electrode 30a exposed from the slit 70x is removed and chamfered. The opening dimension of the slit 70x corresponds to the position of the cut surface Cf of the ridge portion Rd, and is set so that the cut surface Cf does not intersect with the multilayer body 12.

Thus, an inclined portion is formed between the first main surface exposed portion 35a and the first end surface exposed portion 35e.

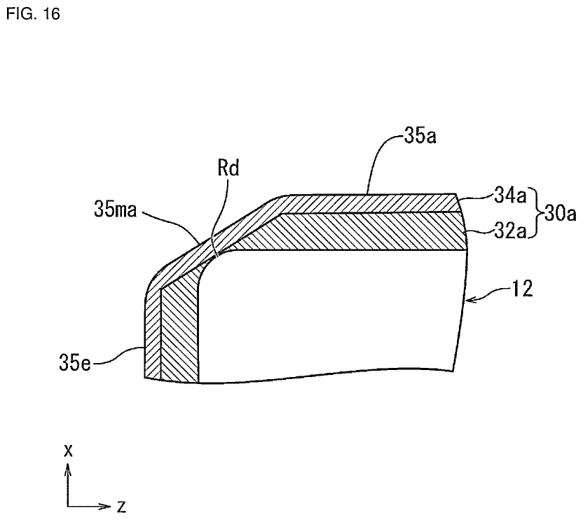

When the first main surface exposed portion 35a and the first end surface exposed portion 35e before forming the inclined portion are formed by the first base electrode layer 32a and the second base electrode layer 32b, the inclined portion is also formed as the base electrode layer 32. By forming the plated layer 34 on these base electrode layers 32, the first outer electrode 30a including the first main surface inclined portion 35ma shown in FIG. 16 is obtained. In this case, the contours of the ridge portion formed by the first main surface inclined portion 35ma and the first main surface exposed portion 35a, and the ridge portion formed by the first main surface inclined portion 35ma and the first end surface exposed portion 35e are formed into gentle roundness due to the formation of the first plated layer 34a.

On the other hand, when the first main surface exposed portion 35a and the first end surface exposed portion 35e before forming the inclined portion are formed by stacking the first base electrode layer 32a, the second base electrode layer 32b, the first plated layer 34a, and the second plated layer 34b, the inclined portion is also formed as a stack of these layers. Specifically, when only the first plated layer 34a and the second plated layer 34b are removed as the ridge portion Rd, as shown in FIG. 9, the surface of the first main surface inclined portion 35ma is formed by each of the first plated layer 34a and the second plated layer 34b.

Moreover, when the first base electrode layer 32a, the second base electrode layer 32b, the first plated layer 34a, and the second plated layer 34b are removed as the ridge portion Rd, the surface of the first main surface inclined portion 35ma as shown in FIG. 10 is formed by each of the first base electrode layer 32a, the second base electrode layer 32b, the first plated layer 34a, and the second plated layer 34b.

In these cases, the first main surface inclined portion 35ma has a planar or substantially planar shape, and edges are formed in the ridge portion formed by the first main surface inclined portion 35ma and the first main surface exposed portion 35a and the ridge portion formed by the first main surface inclined portion 35ma and the first end surface exposed portion 35e by laser processing or sandblasting, respectively.

In this way, the multilayer ceramic capacitor 10 according to the present example embodiment of the present invention is obtained.

### B. Second Example Embodiment

### 1. Multilayer Ceramic Capacitor

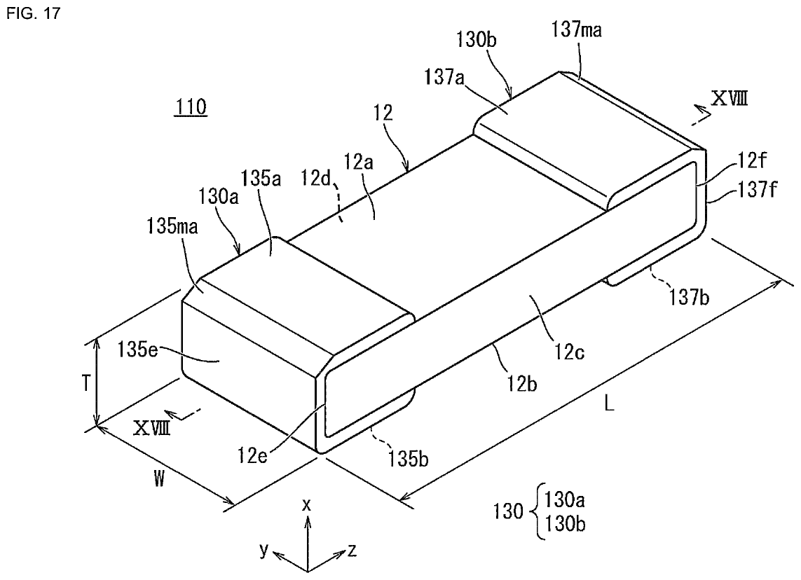

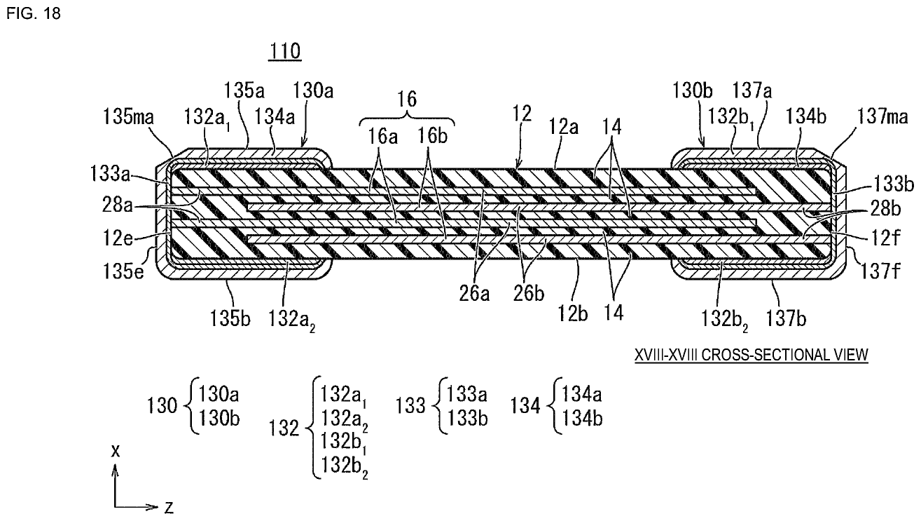

A multilayer ceramic capacitor 110, which is an example of a multilayer ceramic electronic component according to a second example embodiment of the present invention, will be described. FIG. 17 is an external perspective view showing a multilayer ceramic capacitor according to the second example embodiment of the present invention. FIG. 18 is a cross-sectional view taken along line XVIII-XVIII according to FIG. 17. Regarding the multilayer ceramic capacitor 110, the same reference numerals are given to the components corresponding to those in the first example embodiment, and detailed description thereof will be omitted.

The multilayer ceramic capacitor 110 includes a multilayer body 12 and an outer electrode 130. Each configuration will be described below in the order of the multilayer body 12 and the outer electrode 130.

### Multilayer Body

The multilayer body 12 includes a plurality of stacked ceramic layers 14 and a plurality of inner electrode layers 16. The structure of the multilayer body 12 is the same or substantially the same as that of the multilayer ceramic capacitor 10 according to the first example embodiment, and thus description thereof will be omitted.

The material, thickness, number of stacked layers, and the like of the ceramic layer 14 are the same or substantially the same as those of the multilayer ceramic capacitor 10 according to the first example embodiment, and thus description thereof will be omitted.

The dimensions of the multilayer body 12 are not particularly limited.

The inner electrode layer 16 includes a first inner electrode layer 16a and a second inner electrode layer 16b.

The first inner electrode layer 16a includes a first counter electrode portion 26a that faces the second inner electrode layer 16b, and a first extended electrode portion 28a that is located on one end side of the first inner electrode layer 16a and extends from the first counter electrode portion 26a to the first end surface 12e of the multilayer body 12. The end portion of the first extended electrode portion 28a extends and is exposed to the first end surface 12e.

The second inner electrode layer 16b includes a second counter electrode portion 26b that faces the first inner electrode layer 16a, and a second extended electrode portion 28b that is located on one end side of the second inner electrode layer 16b and extends from the second counter electrode portion 26b to the second end surface 12f of the multilayer body 12. The end portion of the second extended electrode portion 28b extends and is exposed to the second end surface 12f.

The material, thickness, number of stacked layers, and the like of the first inner electrode layer 16a and the second inner electrode layer 16b are the same or substantially the same as those of the multilayer ceramic capacitor 10 according to the first example embodiment, and thus description thereof will be omitted.

Outer electrodes 130 are disposed on the first end surface 12e side and the second end surface 12f side of the multilayer body 12.

The outer electrode 130 includes a base electrode layer 132 and end surface plated layers 133 disposed on the first end surface 12e and the second end surface 12f. Further, the outer electrode 130 includes a plated layer 134 that covers the base electrode layer 132 and the end surface plated layer 133.

The outer electrode 130 includes a first outer electrode 130a and a second outer electrode 130b.

The first outer electrode 130a is electrically connected to the first inner electrode layer 16a, and is disposed on the surface of the first end surface 12e of the multilayer body 12, a portion on the first main surface 12a, and a portion on the second main surface 12b. More specifically, the first outer electrode 130a includes a first end surface exposed portion 135e disposed on the surface of the first end surface 12e of the multilayer body 12. It is preferable that the first outer electrode 130a further includes a first main surface exposed portion 135a extending along a contour of the multilayer body 12 from the first end surface 12e with a first main surface inclined portion 135ma, which will be described later, interposed therebetween and covering a portion of the first main surface 12a, and a third main surface exposed portion 135b extending along the contour of the multilayer body 12 from the first end surface 12e and covering a portion of the second main surface 12b. Further, the first outer electrode 130a need not be disposed on a portion of the first side surface 12c and a portion of the second side surface 12d, but may be disposed on a portion of the first side surface 12c and a portion of the second side surface 12d.

The second outer electrode 130b is electrically connected to the second inner electrode layer 16b, and is disposed only on the surface of the second end surface 12f of the multilayer body 12, a portion on the first main surface 12a, and a portion on the second main surface 12b. More specifically, the second outer electrode 130b includes a second end surface exposed portion 137f disposed on the surface of the second end surface 12f of the multilayer body 12. It is preferable that the second outer electrode 130b further includes a second main surface exposed portion 137a extending along the contour of the multilayer body 12 from the second end surface 12f with a second main surface inclined portion 137ma, which will be described later, interposed therebetween and covering a portion of the first main surface 12a, and a fourth main surface exposed portion 137b extending along the contour of the multilayer body 12 from the second end surface 12f and covering a portion of the second main surface 12b. Further, the second outer electrode 130b need not be disposed on a portion of the first side surface 12c and a portion of the second side surface 12d, but may be disposed on a portion of the first side surface 12c and a portion of the second side surface 12d.

In the multilayer body 12, the first counter electrode portion 26a of the first inner electrode layer 16a and the second counter electrode portion 26b of the second inner electrode layer 16b face each other with the ceramic layer 14 interposed therebetween, thus generating an electrostatic capacitance. Therefore, an electrostatic capacitance can be obtained between the first outer electrode 130a to which the first inner electrode layer 16a is connected and the second outer electrode 130b to which the second inner electrode layer 16b is connected, and the characteristics of a capacitor are exhibited.

Furthermore, the first outer electrode 130a of the outer electrode 130 includes a first main surface inclined portion 135ma extending from the first main surface 12a of the multilayer body 12 to the first end surface 12e.

The first main surface inclined portion 135ma is located between the first main surface exposed portion 135a and the first end surface exposed portion 135e of the first outer electrode 130a, and is a plane bent with respect to each of the first main surface exposed portion 135a and the first end surface exposed portion 135e. It is preferable that the first main surface inclined portion 135ma covers the ridge portion of the multilayer body 12. That is, it is preferable that the first main surface inclined portion 135ma does not intersect with the multilayer body 12 and does not expose the surface of the multilayer body 12 on the first main surface inclined portion 135ma.

Similarly, the second outer electrode 130b of the outer electrode 130 includes a second main surface inclined portion 137ma formed from the first main surface 12a of the multilayer body 12 to the second end surface 12f.

The second main surface inclined portion 137ma is located between the second main surface exposed portion 137a and the second end surface exposed portion 137f of the second outer electrode 130b, and is a plane bent with respect to each of the second main surface exposed portion 137a and the second end surface exposed portion 137f. It is preferable that the second main surface inclined portion 137ma covers the ridge portion of the multilayer body 12. That is, it is preferable that the second main surface inclined portion 137ma does not intersect with the multilayer body 12 and does not expose the surface of the multilayer body 12 on the second main surface inclined portion 137ma.

Next, the internal configuration of the outer electrode 130 will be described.

The base electrode layer 132 includes a first base electrode layer 132a1, a second base electrode layer 132b1, a third base electrode layer 132a2, and a fourth base electrode layer 132b2. The first base electrode layer 132al, the second base electrode layer 132b1, the third base electrode layer 132a2, and the fourth base electrode layer 132b2 are thin film layers including a plurality of thin film electrodes in order to further improve performance.

The first base electrode layer 132al covers a portion of the first main surface 12a on the first end surface 12e side of the multilayer body 12. The second base electrode layer 132b1 covers a portion of the first main surface 12a on the second end surface 12f side of the multilayer body 12.

Further, the third base electrode layer 132a2 covers a portion of the second main surface 12b on the first end surface 12e side of the multilayer body 12. The fourth base electrode layer 132b2 covers a portion of the second main surface 12b on the second end surface 12f side of the multilayer body 12.

The base electrode layer 132 defined by a thin film layer is preferably formed by a thin film forming method such as a sputtering method or a vapor deposition method, for example. In particular, the base electrode layer 132 defined by the thin film layer is preferably a sputtered electrode formed by a sputtering method, for example. Hereinafter, electrodes formed by the sputtering method will be described.

When forming the base electrode layer 132 using sputtered electrodes, it is preferable to form the sputtered electrodes directly on a portion on the first main surface 12a and a portion on the second main surface 12b of the multilayer body 12.

The base electrode layer 132 formed using sputtered electrodes includes, for example, at least one of Ni, Cr, Cu, and the like.

The thickness in the height direction x connecting the first main surface 12a and the second main surface 12b of the sputtered electrode is, for example, preferably about 50 nm or more and about 400 nm or less, and more preferably about 50 nm or more and about 130 nm or less.

The end surface plated layer 133 includes a first end surface plated layer 133a and a second end surface plated layer 133b.

The first end surface plated layer 133a is disposed on the first end surface 12e to cover the region including the first extended electrode portion 28a of the first inner electrode layer 16a exposed on the first end surface 12e and the first base electrode layer 132al and the third base electrode layer 132a2.

The second end surface plated layer 133b is disposed on the second end surface 12f to cover the region including the second extended electrode portion 28b of the second inner electrode layer 16b exposed on the second end surface 12f and the second base electrode layer 132b1 and the fourth base electrode layer 132b2.

Further, when forming sputtered electrodes directly on a portion of the first main surface 12a and a portion of the second main surface 12b of the multilayer body 12 to dispose the base electrode layer 132 and disposing the end surface plated layer 133 on the first end surface 12e and the second end surface 12f, it is preferable to directly form a first plated layer 134a and a second plated layer 134b, which are plated layers 134 to be described later.

The plated layer 134 includes a first plated layer 134a and a second plated layer 134b. The structure of the plated layer 134 is the same or substantially the same as that of the multilayer ceramic capacitor 10 according to the first example embodiment, and thus description thereof will be omitted.

The structure of the outer electrode 30 described in Modified Example 1 and Modified Example 2 of the first example embodiment can be applied to the outer electrode 130 of the multilayer ceramic capacitor 110 according to the second example embodiment.

This multilayer ceramic capacitor 110 has the same or substantially the same advantageous effects as the multilayer ceramic capacitor 10 according to the first example embodiment.

### 2. Method for Manufacturing Multilayer Ceramic Capacitor

The method for manufacturing the multilayer body 12 is, for example, the same or substantially the same as the method for manufacturing the multilayer ceramic capacitor according to the first example embodiment, and thus description thereof will be omitted. An example of a method for manufacturing the outer electrode 130 of the multilayer ceramic capacitor 110 will be described below.

A first base electrode layer 132al and a second base electrode layer 132b1, which are base electrode layers 132 made of thin film layers, are formed on a portion on the first main surface 12a of the multilayer body 12. Further, a third base electrode layer 132a2 and a fourth base electrode layer 132b2, which are base electrode layers 132 made of thin film layers, are formed on a portion on the second main surface 12b of the multilayer body 12. The thin film layer can be formed using a sputtering method, for example, from a portion on the first main surface 12a and from the second main surface 12b. At this time, depending on the range and conditions in which the sputtering method is performed, it may be provided not only on a portion on the first main surface 12a and the second main surface 12b but also over the corner portions and ridge portions of the multilayer body 12, the first end surface 12e, and the second end surface 12f.

The sputtered electrode can be formed of, for example, a metal including at least one of Ni, Cr, Cu, Ti, and the like.

The plated layer formed after forming the base electrode layer 132 is formed as follows.

On the first end surface 12e and the second end surface 12f of the multilayer body 12, a first end surface plated layer 133a and a second end surface plated layer 133b are formed to cover the exposed region of the inner electrode layer 16 and the base electrode layer 132.

The first end surface plated layer 133a and the second end surface plated layer 133b are formed as, for example, Ni plated layers.

The Ni plated layer is formed, for example, by electrolytic plating using an electrolytic plating bath including a citric acid additive, or by electroless plating using a substitution reaction.

By changing the plating conditions when forming the Ni plated layer, for example, conditions such as bath temperature and bath ion concentration, and conditions such as current density in the case of electrolytic plating, and by heat treatment performed after forming the Ni plated layer, the desired thickness and metal particle size of the Ni plated layer can be achieved. The heat treatment conditions are, for example, preferably in the temperature range of about 300° C. to about 900° C. for about 0.5 to about 12 hours.

Further, Sn plated layers are formed as the first plated layer 134a and the second plated layer 134b on the Ni plated layer and on the first end surface 12e and the second end surface 12f where the Ni plated layer is not disposed. Here, the Sn plated layer is formed, for example, by electrolytic plating using an electrolytic plating bath including a citric acid additive, or by electroless plating using a substitution reaction.

By changing the plating conditions when forming the Sn plated layer, for example, conditions such as bath temperature and bath ion concentration, and conditions such as current density in the case of electrolytic plating, and by heat treatment performed after forming the Sn plated layer, the desired thickness and metal particle size of the Sn plated layer can be achieved.

The Sn plated layer may include, for example, at least one of Cu, Ni, Sn, Ag, Pd, an Ag—Pd alloy, Au, and the like, and may be a plated layer including a single layer or a plurality of layers.

Subsequently, the inclined portions that become the first main surface inclined portion 135ma and the second main surface inclined portion 137ma are formed when the outer electrode 130 is formed.

As the method for forming the inclined portion, it is preferable to use a forming method using, for example, the laser processing or sandblasting described in the method for manufacturing the multilayer ceramic capacitor in the first example embodiment.

### C. Third Example Embodiment

### 1. Multilayer Ceramic Capacitor

A multilayer ceramic capacitor according to an example embodiment of the present invention will be described.

Specifically, a multilayer ceramic capacitor 210 of the third example embodiment of the present invention is a thin multilayer ceramic capacitor 210 in which the T dimension is smaller than the W dimension, as shown in FIGS. 1 to 3.

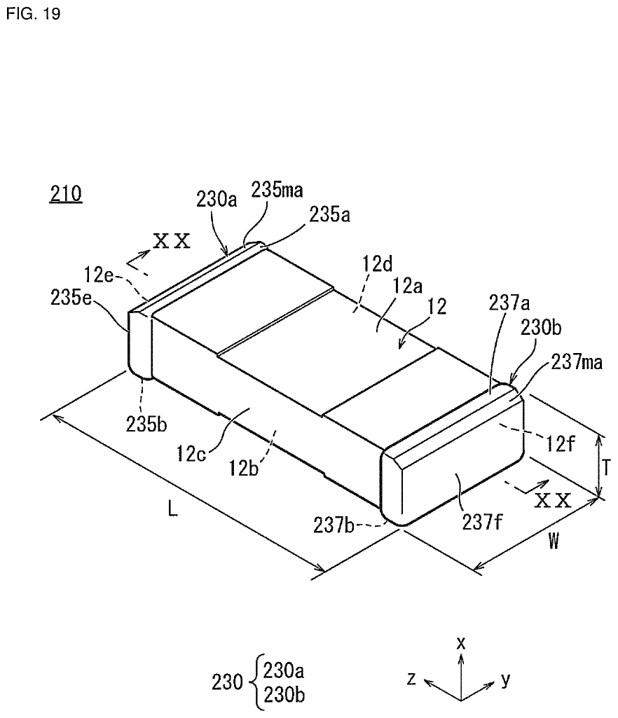

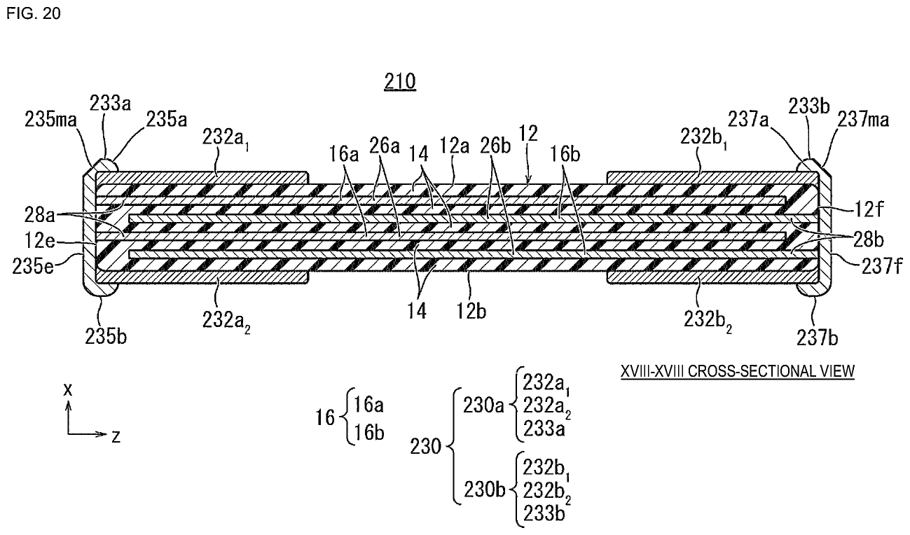

A multilayer ceramic capacitor 210 according to a third example embodiment of the present invention will be described. FIG. 19 is an external perspective view showing a multilayer ceramic capacitor according to a third example embodiment of the present invention. FIG. 20 is a cross-sectional view taken along line XX-XX according to FIG. 19. Regarding the multilayer ceramic capacitor 210, the same reference numerals are given to the components corresponding to those in the first example embodiment, and detailed description thereof will be omitted.

The multilayer ceramic capacitor 210 includes a multilayer body 12 and an outer electrode 230.

### Multilayer Body

The multilayer body 12 includes a plurality of stacked ceramic layers 14 and a plurality of inner electrode layers 16.

The material, thickness, number of stacked layers, and the like of the ceramic layer 14 are the same or substantially the same as those of the multilayer ceramic capacitor 10 according to the first example embodiment, and thus description thereof will be omitted.

The dimensions of the multilayer body 12 are not particularly limited.

The inner electrode layer 16 includes a first inner electrode layer 16a and a plurality of second inner electrode layers 16b.

The first inner electrode layer 16a includes a first counter electrode portion 26a that faces the second inner electrode layer 16b, and a first extended electrode portion 28a that is located on one end side of the first inner electrode layer 16a and extends from the first counter electrode portion 26a to the first end surface 12e of the multilayer body 12. The end portion of the first extended electrode portion 28a is drawn out and exposed to the first end surface 12e.

The second inner electrode layer 16b includes a second counter electrode portion 26b that faces the first inner electrode layer 16a, and a second extended electrode portion 28b that is located on one end side of the second inner electrode layer 16b and extends from the second counter electrode portion 26b to the second end surface 12f of the multilayer body 12. The end portion of the second extended electrode portion 28b is drawn out and exposed to the second end surface 12f.

The material, thickness, number of stacked layers, and the like of the first inner electrode layer 16a and the second inner electrode layer 16b are the same or substantially the same as those of the multilayer ceramic capacitor 10 according to the first example embodiment, and thus description thereof will be omitted.

Outer electrodes 230 are disposed on the first end surface 12e side and the second end surface 12f side of the multilayer body 12.

The outer electrode 230 includes a base electrode layer 232 and end surface electrodes 233 disposed on the first end surface 12e and the second end surface 12f.

The outer electrode 230 includes a first outer electrode 230a and a second outer electrode 230b.

The first outer electrode 230a is electrically connected to the first inner electrode layer 16a, and is disposed on the surface of the first end surface 12e of the multilayer body 12, a portion on the first main surface 12a, and a portion on the second main surface 12b. More specifically, the first outer electrode 230a includes a first end surface exposed portion 235e disposed on the surface of the first end surface 12e of the multilayer body 12. It is preferable that the first outer electrode 130a further includes a first main surface exposed portion 235a extending along a contour of the multilayer body 12 from the first end surface 12e with a first main surface inclined portion 235ma, which will be described later, interposed therebetween and covering a portion of the first main surface 12a, and a third main surface exposed portion 235b extending along the contour of the multilayer body 12 from the first end surface 12e and covering a portion of the second main surface 12b.

The first outer electrode 230a is electrically connected to the second inner electrode layer 16b, and is disposed on the surface of the first end surface 12e of the multilayer body 12, a portion on the first main surface 12a, and a portion on the second main surface 12b. More specifically, the second outer electrode 230b includes a second end surface exposed portion 237f disposed on the surface of the second end surface 12f of the multilayer body 12. It is preferable that the second outer electrode 230b further includes a second main surface exposed portion 237a extending along the contour of the multilayer body 12 from the second end surface 12f with a second main surface inclined portion 237ma, which will be described later, interposed therebetween and covering a portion of the first main surface 12a, and a fourth main surface exposed portion 237b extending along the contour of the multilayer body 12 from the second end surface 12f and covering a portion of the second main surface 12b.

In the multilayer body 12, the first counter electrode portion 26a of the first inner electrode layer 16a and the second counter electrode portion 26b of the second inner electrode layer 16b face each other with the ceramic layer 14 interposed therebetween, thus generating an electrostatic capacitance. Therefore, an electrostatic capacitance can be obtained between the first outer electrode 230a to which the first inner electrode layer 16a is connected and the second outer electrode 230b to which the second inner electrode layer 16b is connected, and the characteristics of a capacitor are exhibited.

Furthermore, the first outer electrode 230a of the outer electrode 230 includes a first main surface inclined portion 235ma defined by the first main surface 12a of the multilayer body 12 to the first end surface 12e.

The first main surface inclined portion 235ma is located between the first main surface exposed portion 235a and the first end surface exposed portion 235e of the first outer electrode 230a, and is a plane bent with respect to each of the first main surface exposed portion 235a and the first end surface exposed portion 235e. It is preferable that the first main surface inclined portion 235ma covers the ridge portion of the multilayer body 12. That is, it is preferable that the first main surface inclined portion 235ma does not intersect with the multilayer body 12 and does not expose the surface of the multilayer body 12 on the first main surface inclined portion 235ma.

Similarly, the second outer electrode 230b of the outer electrode 230 includes a second main surface inclined portion 237ma defined by the first main surface 12a of the multilayer body 12 to the second end surface 12f.

The second main surface inclined portion 237ma is located between the second main surface exposed portion 237a and the second end surface exposed portion 237f of the second outer electrode 230b, and is a plane bent with respect to each of the second main surface exposed portion 237a and the second end surface exposed portion 237f. It is preferable that the second main surface inclined portion 237ma covers the ridge portion of the multilayer body 12. That is, it is preferable that the second main surface inclined portion 237ma does not intersect with the multilayer body 12 and does not expose the surface of the multilayer body 12 on the second main surface inclined portion 237ma.

Next, the internal configuration of the outer electrode 230 will be described.

The first outer electrode 230a includes a first base electrode layer 232a1, a third base electrode layer 232a2, and a first end surface electrode 233a.

The second outer electrode 230b includes a second base electrode layer 232b1, a fourth base electrode layer 232b2, and a second end surface electrode 233b.

The first base electrode layer 232al covers a portion of the first main surface 12a on the first end surface 12e side of the multilayer body 12.

The second base electrode layer 232b1 covers a portion of the first main surface 12a on the second end surface 12f side of the multilayer body 12.

The third base electrode layer 232a2 covers a portion of the second main surface 12b on the first end surface 12e side of the multilayer body 12.

The fourth base electrode layer 232b2 covers a portion of the second main surface 12b on the second end surface 12f side of the multilayer body 12.

The first end surface electrode 233a is located on the surface of the first end surface 12e, and covers a portion of the first base electrode layer 232al and a portion of the third base electrode layer 232a2.

The second end surface electrode 233b is located on the surface of the second end surface 12f, and covers a portion of the second base electrode layer 232b1 and a portion of the fourth base electrode layer 232b2.

The structure of the outer electrode 30 described in Modified Example 1 and Modified Example 2 of the first example embodiment can be applied to the outer electrode 230 of the multilayer ceramic capacitor 210 according to the third example embodiment.

This multilayer ceramic capacitor 210 has the same or substantially the same advantageous effects as the multilayer ceramic capacitor 10 according to the first example embodiment.

### 2. Method for Manufacturing Multilayer Ceramic Capacitor

The method for manufacturing the multilayer chip before firing is the same or substantially the same as the method for manufacturing the multilayer ceramic capacitor according to the first example embodiment, and thus description thereof will be omitted. An example of a method for manufacturing the outer electrode 230 of the multilayer ceramic capacitor 210 will be described below.

Each of the first base electrode layer 232al, the second base electrode layer 232b1, the third base electrode layer 232a2, and the fourth base electrode layer 232b2 of the base electrode layer 232 consisting of a thin film electrode layer is formed by, for example, screen-printing a conductive material on a portion of the first main surface 12a and a portion of the second main surface 12b of the multilayer body 12 before firing. In this case, for example, it is preferable to use Ni as the conductive material. Next, as shown in FIG. 20, after firing the multilayer body 12 after forming the first base electrode layer 232al and the third base electrode layer 232a2, the conductive material is further dipped onto the first end surface 12e to form a first end surface electrode 233a. In this case, it is preferable to use Cu as the conductive material. Similarly, after firing the multilayer body 12 after forming the second base electrode layer 232b1 and the fourth base electrode layer 232b2, the conductive material is further dipped onto the second end surface 12f to form a second end surface electrode 233b.

The end surface electrode 233 may be formed by, for example, applying a conductive material on the first end surface 12e and the second end surface 12f before firing the multilayer body 12 after forming the base electrode layer 232, and then firing the multilayer body 12. In this case, for example, it is preferable to use Ni as the conductive material.

Further thereafter, for example, a Cu plated layer is formed as necessary.

The Cu plated layer is formed by processes of Cu plating, vacuum heat treatment, and Cu plating heat treatment, for example.

First, the first outer electrode 230a and the second outer electrode 230b are subjected to Cu plating to form a Cu plated layer.

After this, as necessary, the first outer electrode 230a and the second outer electrode 230b on which the Cu plated layer is formed are subjected to nickel plating and tin plating to form a nickel plating and tin plated layer of the first outer electrode 230a and the second outer electrode 230b. Note that the first outer electrode 230a and the second outer electrode 230b may be subjected to nickel plating and tin plating to form a nickel plating and tin plated layer without forming the Cu plated layer.

Subsequently, the inclined portions that become the first main surface inclined portion 235ma and the second main surface inclined portion 237ma are formed when the outer electrode 230 is formed.

As the method for forming the inclined portion, for example, it is preferable to use a forming method using the laser processing or sandblasting described in the method for manufacturing the multilayer ceramic capacitor in the first example embodiment.

### D. Experimental Example

A multilayer ceramic capacitor was produced using the method for manufacturing a multilayer ceramic capacitor according to the first example embodiment.

### (a) Specification of Sample of Example

A multilayer ceramic capacitor with the following specifications was prepared as a sample.
Dimensions (design values) of multilayer ceramic capacitors: Listed in Table 1
Main component material of ceramic layer: BaTiO₃
Capacitance: about 220 μF
Rated Voltage: about 4 V
Electrode material of inner electrode layer: Ni
Structure of outer electrode:
Base electrode layer: Electrode including conductive metal (Cu) and glass component

Thickness of base electrode layer: Thickness at central portion in length direction of base electrode layer located on first main surface and second main surface: about 3 μm
Plated layer: Two-layer structure of Ni plated layer and Sn plated layer

Ni plated layer thickness: Thickness at central portion in length direction of Ni plated layer located on first main surface and second main surface: about 3 μm

Sn plated layer thickness: Thickness at central portion in length direction of Sn plated layer located on first main surface and second main surface: about 3 μm

### (b) Evaluation of Mechanical Strength by Temperature Cycle

The samples of the multilayer ceramic capacitors having Sample No. 1 to Sample No. 6 after Sn plating were reflow mounted with solder on a predetermined evaluation board, and the temperature in the experimental chamber was varied from about −55° C. to about 125° C. at about 30 minute intervals. After carrying out 200 cycles of changing temperature between about −55° C. and about 125° C. as one cycle, the chip together with the board was polished along the width direction y, and the LT cross section exposed by polishing was observed with a microscope. The number of samples for each sample number was 10.

Regarding each sample, if no cracks occurred in the outer electrode and the crack occurrence rate was 0%, it was evaluated as A. If a crack occurred in the outer electrodes of the sample, but the length of the crack was about ½ or less of the thickness of the outer electrode for all samples in which cracks occurred, it was evaluated as B. If a crack occurred in the outer electrode of the sample, but the length of the crack was greater than about ½ of the thickness of the outer electrode and smaller than the thickness of the outer electrode for all samples in which cracks occurred, it was evaluated as C. If a crack occurred in the outer electrode of the sample and the crack extended to the multilayer body, or if one or more of the cracks had a length longer than the thickness of the outer electrode, it was evaluated as D.

### (d) Results

Table 1 shows the crack evaluation results for samples having Sample No. 1 to Sample No. 6.

TABLE 1

| Sample No. | 1 | 2 | 3 | 4 | 5 | 6 |
|---|---|---|---|---|---|---|
| L dimension of multilayer | 600 | 600 | 600 | 600 | 600 | 600 |
| ceramic capacitor (μm) | | | | | | |
| W dimension of multilayer | 300 | 300 | 300 | 300 | 300 | 300 |
| ceramic capacitor (μm) | | | | | | |
| Dimension in height direction | 57 | 57 | 57 | 57 | 57 | 57 |
| of multilayer body (μm) | | | | | | |
| Thickness of outer electrode | 9.0 | 8.9 | 9.0 | 8.9 | 9.0 | 9.1 |
| on main surface (μm) | | | | | | |
| Angle (β) of first and second | 90 | 110 | 120 | 150 | 170 | 175 |
| main surface inclined | | | | | | |
| portions (°) | | | | | | |
| Crack evaluation | D | C | B | A | B | C |

According to Table 1, the crack evaluation of the multilayer ceramic capacitors according to Sample No. 3 to Sample No. 5 in which the angle β of the first main surface inclined portion 35ma was in the range of about 120° or more and about 170° or less was evaluated as “B” or “A” as good quality.

Further, the crack evaluation of the multilayer ceramic capacitor according to Sample No. 2 in which the angle β of the first main surface inclined portion 35ma was about 110° was evaluated as “C”. Similarly, the crack evaluation of the multilayer ceramic capacitor according to Sample No. 6 in which the angle β of the first main surface inclined portion 35ma was larger than about 170° was evaluated as “C”.

On the other hand, the crack evaluation of the multilayer ceramic capacitor according to Sample No. 1 in which the angle β of the first main surface inclined portion 35ma was about 90°, that is, the inclined portion was not provided, was evaluated as “D”.

From the above, according to this experiment, it has been shown that by providing the first main surface inclined portion and the second main surface inclined portion in the outer electrode, it is possible to reduce or prevent cracks extending at least to the multilayer body.

Further, according to this experiment, it has been shown that by providing the first main surface inclined portion and the second main surface inclined portion in which the angle β of the inclined portion is in the range of about 120° or more and about 170° or less, it is possible to reduce the influence of thermal stress due to solder shrinkage while reducing or preventing the expansion of component dimensions without separately providing a structure for stress absorption such as a conductive resin layer in the outer electrode.

Although the example embodiments of the present invention have been disclosed in the above description, the present invention is not limited thereto.

In the above example embodiments, a two-terminal multilayer ceramic capacitor 10 has been described as an example, but the multilayer ceramic capacitor of the present invention may be a three-terminal multilayer ceramic capacitor, a thermistor element, or an inductor element, for example.

In short, the multilayer ceramic electronic component of the present invention only needs to include a multilayer body including a plurality of inner electrode layers that are arranged to face each other and be spaced apart from each other, and a ceramic layer including a ceramic material disposed between the plurality of inner electrode layers, and is not limited by the specific purpose, function, and configuration of the component, such as the number and shape of the multilayer bodies, outer electrodes, and inner electrode layers connected to the outer electrodes.

Including what has been described above, the present invention enables various changes to be made to the example embodiments described above in terms of configuration, shape, material, quantity, position, arrangement, and the like without departing from the scope of the technical idea and purpose of the present invention, and these are included in the present invention.

Example embodiments of the present invention as described above achieve advantageous effects including reducing the influence of thermal stress due to solder shrinkage while reducing or preventing an increase in the dimensions of the component, and improve multilayer ceramic electronic components.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including a plurality of stacked ceramic layers, a first main surface and a second main surface facing each other in a height direction, a first side surface and a second side surface facing each other in a width direction orthogonal or substantially orthogonal to a stacking direction of the plurality of ceramic layers, a first end surface and a second end surface facing each other in a length direction orthogonal or substantially orthogonal to the stacking direction and the width direction, a first inner electrode layer stacked alternately with the plurality of ceramic layers and exposed on the first end surface, and a second inner electrode layer stacked alternately with the plurality of ceramic layers and exposed on the second end surface;
a first outer electrode extending from the first end surface of the multilayer body to each of the first main surface and the second main surface; and
a second outer electrode extending from the second end surface of the multilayer body to each of the first main surface and the second main surface; wherein
the first outer electrode includes a first main surface inclined portion extending from a side of the first main surface of the multilayer body to a side of the first end surface; and
the second outer electrode includes a second main surface inclined portion extending from the side of the first main surface of the multilayer body to a side of the second end surface.

2. The multilayer ceramic electronic component according to claim 1, wherein
the first outer electrode includes a first base electrode layer and a third base electrode layer defined by sputtered electrodes, and a first end surface plated layer;
the second outer electrode includes a second base electrode layer and a fourth base electrode layer defined by sputtered electrodes, and a second end surface plated layer;
the first base electrode layer covers a portion of the first main surface on the side of the first end surface of the multilayer body;
the second base electrode layer covers a portion of the first main surface on the side of the second end surface of the multilayer body;
the third base electrode layer covers a portion of the second main surface on the side of the first end surface of the multilayer body;
the fourth base electrode layer covers a portion of the second main surface on the side of the second end surface of the multilayer body;
the first end surface plated layer is provided on the first end surface and covers a region including the first inner electrode layer exposed on the first end surface and the first base electrode layer and the third base electrode layer; and
the second end surface plated layer is provided on the second end surface and covers a region including the second inner electrode layer exposed on the second end surface and the second base electrode layer and the fourth base electrode layer.

3. The multilayer ceramic electronic component according to claim 1, wherein
the first outer electrode includes a first base electrode layer and a third base electrode layer which are screen-printed, and a first end surface electrode;
the second outer electrode includes a second base electrode layer and a fourth base electrode layer, which are screen-printed, and a second end surface electrode;
the first base electrode layer covers a portion of the first main surface on the side of the first end surface of the multilayer body;
the second base electrode layer covers a portion of the first main surface on the side of the second end surface of the multilayer body;
the third base electrode layer covers a portion of the second main surface on the side of the first end surface of the multilayer body;
the fourth base electrode layer covers a portion of the second main surface on the side of the second end surface of the multilayer body;
the first end surface electrode is provided on a surface of the first end surface, and covers a portion of the first base electrode layer and a portion of the third base electrode layer; and
the second end surface electrode is provided on a surface of the second end surface, and covers a portion of the second base electrode layer and a portion of the fourth base electrode layer.

4. The multilayer ceramic electronic component according to claim 1, wherein
the first main surface inclined portion of the first outer electrode covers a ridge portion defined by the first main surface and the first end surface of the multilayer body; and
the second main surface inclined portion of the second outer electrode covers a ridge portion defined by the first main surface and the second end surface of the multilayer body.

5. The multilayer ceramic electronic component according to claim 1, wherein
the first outer electrode includes a third main surface inclined portion extending from a side of the second main surface of the multilayer body to the side of the first end surface; and
the second outer electrode includes a fourth main surface inclined portion extending from the side of the second main surface of the multilayer body to the side of the second end surface.

6. The multilayer ceramic electronic component according to claim 5, wherein
the third main surface inclined portion of the first outer electrode covers a ridge portion defined by the second main surface and the first end surface of the multilayer body; and
the fourth main surface inclined portion of the second outer electrode covers a ridge portion defined by the second main surface and the second end surface of the multilayer body.

7. The multilayer ceramic electronic component according to claim 1, wherein
the first outer electrode includes:
a first side surface inclined portion extending from the side of the first main surface of the multilayer body to a side of the first side surface;
a second side surface inclined portion extending from the side of the first main surface of the multilayer body to a side of the second side surface;
a third side surface inclined portion extending from a side of the second main surface of the multilayer body to the side of the first side surface; and
a fourth side surface inclined portion extending from the side of the second main surface of the multilayer body to the side of the second side surface; and
the second outer electrode includes:
a fifth side surface inclined portion extending from the side of the first main surface of the multilayer body to the side of the first side surface;
a sixth side surface inclined portion extending from the side of the first main surface of the multilayer body to the side of the second side surface;
a seventh side surface inclined portion extending from the side of the second main surface of the multilayer body to the side of the first side surface; and
an eighth side surface inclined portion extending from the side of the second main surface of the multilayer body to the side of the second side surface.

8. The multilayer ceramic electronic component according to claim 7, wherein
in the first outer electrode:
the first side surface inclined portion covers a ridge portion defined by the first main surface and the first side surface of the multilayer body;
the second side surface inclined portion covers a ridge portion defined by the first main surface and the second side surface of the multilayer body;
the third side surface inclined portion covers a ridge portion defined by the second main surface and the first side surface of the multilayer body; and
the fourth side surface inclined portion covers a ridge portion defined by the second main surface and the second side surface of the multilayer body; and
in the second outer electrode:
the fifth side surface inclined portion covers a ridge portion defined by the first main surface and the first side surface of the multilayer body;
the sixth side surface inclined portion covers a ridge portion defined by the first main surface and the second side surface of the multilayer body;
the seventh side surface inclined portion covers a ridge portion defined by the second main surface and the first side surface of the multilayer body; and
the eighth side surface inclined portion covers a ridge portion defined by the second main surface and the second side surface of the multilayer body.

9. The multilayer ceramic electronic component according to claim 1, wherein
in the first outer electrode, an angle between a first main surface exposed portion provided on the first main surface of the multilayer body and the first main surface inclined portion is about 120° or more and about 170° or less; and
in the second outer electrode, an angle between a second main surface exposed portion provided on the first main surface of the multilayer body and the second main surface inclined portion is about 120° or more and about 170° or less.

10. The multilayer ceramic electronic component according to claim 5, wherein
in the first outer electrode, an angle between a third main surface exposed portion provided on the second main surface of the multilayer body and the third main surface inclined portion is about 120° or more and about 170° or less, and
in the second outer electrode, an angle between a fourth main surface exposed portion provided on the second main surface of the multilayer body and the fourth main surface inclined portion is about 120° or more and about 170° or less.

11. The multilayer ceramic electronic component according to claim 7, wherein
in the first outer electrode, an angle between a first main surface exposed portion provided on the first main surface of the multilayer body and the first side surface inclined portion, an angle between the first main surface exposed portion and the second side surface inclined portion of the multilayer body, an angle between a second main surface exposed portion provided on the second main surface of the multilayer body and the third side surface inclined portion, and an angle between the second main surface exposed portion and the fourth side surface inclined portion of the multilayer body are about 120° or more and about 170° or less; and
in the second outer electrode, an angle between the first main surface exposed portion and the fifth side surface inclined portion of the multilayer body, an angle between the first main surface exposed portion and the sixth side surface inclined portion of the multilayer body, an angle between the second main surface exposed portion and the seventh side surface inclined portion of the multilayer body, and an angle between the second main surface exposed portion and the eighth side surface inclined portion of the multilayer body are about 120° or more and about 170° or less.

12. The multilayer ceramic electronic component according to claim 1, wherein each of the plurality of ceramic layers includes BaTiO₃, CaTio₃, SrTiO₃, or CaZro₃ as a main component.

13. The multilayer ceramic electronic component according to claim 12, wherein each of the plurality of ceramic layers includes a Mn compound, an Fe compound, a Cr compound, a Co compound, or a Ni compound as a subcomponent.

14. The multilayer ceramic electronic component according to claim 1, wherein a thickness of each of the plurality of ceramic layers is about 0.4 μm or more and about 5.0 μm or less.

15. The multilayer ceramic electronic component according to claim 1, wherein a number of the plurality of ceramic layers is 10 or more and 700 or less.

16. The multilayer ceramic electronic component according to claim 1, wherein each of the first and second inner electrode layers includes Ni, Cu, Ag, Pd, or Au, or an alloy including at least one of Ni, Cu, Ag, Pd, or Au.

17. The multilayer ceramic electronic component according to claim 1, wherein a thickness of each of the first and second inner electrode layers is about 0.2 μm or more and about 2.0 μm or less.

18. The multilayer ceramic electronic component according to claim 2, wherein each of the first, second, third, and fourth base electrode layers is defined by a baked layer including a glass component and a metal.

19. The multilayer ceramic electronic component according to claim 18, wherein the glass component includes at least one of B, Si, Ba, Mg, Al, or Li.

20. The multilayer ceramic electronic component according to claim 18, wherein the metal includes at least one of Cu, Ni, Ag, Pd, an Ag—Pd alloy, or Au.
